(19) United States
(12) Patent Application Publication
(10) Pub. No.: US 2026/0303253 A1
(43) Pub. Date: Oct. 1, 2026

(54) CODING RATE CONTROL FOR HOLOGRAPHIC COMMUNICATIONS

(71) Applicant: QUALCOMM Incorporated, San Diego, CA (US)

(72) Inventors: Mickael MONDET, Louannec (FR); Peerapol TINNAKORNSRISUPHAP, San Diego, CA (US); Saadallah KASSIR, San Diego, CA (US); Prashanth Haridas HANDE, San Diego, CA (US)

(21) Appl. No.: 19/089,400

(22) Filed: Mar. 25, 2025

(51) Int. Cl. H04L 1/00; H04W 28/02

(52) U.S. Cl. CPC H04L 1/0009; H04W 28/0284; H04W 28/0289

(57) ABSTRACT

This disclosure provides methods, components, devices and systems for coding rate control for holographic communications. Aspects relate to an encoding layer selection at an application server associated with a holographic communications session on a per destination basis. A transmitting device may encode a set of packets in accordance with a set of encoding layers and transmit multiple coded versions of the set of packets to the application server. The application server may select a respective coded version of the set of packets for transmission to each other device associated with the holographic communications session. Further aspects relate to a selective re-encoding operation at the application server on a per destination basis. A transmitting device may indicate a set of transcoding parameters to the application server. The application server may selectively re-encode a set of packets from the transmitting device using the set of transcoding parameters on a per destination basis.

### TECHNICAL FIELD

This disclosure relates generally to wireless communication, and more specifically to systems, devices, methods, and techniques associated with coding rate control for holographic communications.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, or spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by an application server is described. The method may include obtaining a feedback message that includes congestion information pertaining to a traffic flow associated with holographic communications between a set of multiple wireless communication devices, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, obtaining a first set of packets of the traffic flow associated with the holographic communications, where the first set of packets is associated with a set of multiple encoding layers that correspond to a layered encoding scheme at the second wireless communication device, and outputting a second set of packets that corresponds to the first set of packets in accordance with a selection, at the application server, of a respective encoding layer of the set of multiple encoding layers on a per-destination basis, where the selection is based on the congestion information.

An application server for wireless communication is described. The application server may include a processing system that includes processor circuitry and memory circuitry that stores code. The processing system may be configured to cause the application server to obtain a feedback message that includes congestion information pertaining to a traffic flow associated with holographic communications between a set of multiple wireless communication devices, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, obtain a first set of packets of the traffic flow associated with the holographic communications, where the first set of packets is associated with a set of multiple encoding layers that correspond to a layered encoding scheme at the second wireless communication device, and output a second set of packets that corresponds to the first set of packets in accordance with a selection, at the application server, of a respective encoding layer of the set of multiple encoding layers on a per-destination basis, where the selection is based on the congestion information.

Another application server for wireless communication is described. The application server may include means for obtaining a feedback message that includes congestion information pertaining to a traffic flow associated with holographic communications between a set of multiple wireless communication devices, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, means for obtaining a first set of packets of the traffic flow associated with the holographic communications, where the first set of packets is associated with a set of multiple encoding layers that correspond to a layered encoding scheme at the second wireless communication device, and means for outputting a second set of packets that corresponds to the first set of packets in accordance with a selection, at the application server, of a respective encoding layer of the set of multiple encoding layers on a per-destination basis, where the selection is based on the congestion information.

A non-transitory computer-readable medium storing code for wireless communication is described. The code may include instructions executable by one or more processors to obtain a feedback message that includes congestion information pertaining to a traffic flow associated with holographic communications between a set of multiple wireless communication devices, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, obtain a first set of packets of the traffic flow associated with the holographic communications, where the first set of packets is associated with a set of multiple encoding layers that correspond to a layered encoding scheme at the second wireless communication device, and output a second set of packets that corresponds to the first set of packets in accordance with a selection, at the application server, of a respective encoding layer of the set of multiple encoding layers on a per-destination basis, where the selection is based on the congestion information.

In some examples of the method, application servers, and non-transitory computer-readable medium described herein, outputting the second set of packets may include operations, features, means, or instructions for outputting a first coded version of the second set of packets according to a first encoding layer of the set of multiple encoding layers based on the congestion information, where a first destination of the first coded version of the second set of packets may be the first wireless communication device and outputting a second coded version of the second set of packets according to a second encoding layer of the set of multiple encoding layers different than the first encoding layer, where a second destination of the second coded version of the second set of packets may be a third wireless communication device of the set of multiple wireless communication devices.

In some examples of the method, application servers, and non-transitory computer-readable medium described herein, the first encoding layer may be associated with a lower coding rate than the second encoding layer.

A method for wireless communication by a first wireless communication device is described. The method may include transmitting a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and receiving a set of packets of the traffic flow associated with the holographic communications according to an encoding layer, of a set of multiple encoding layers that correspond to a layered encoding scheme at the second wireless communication device, based on the congestion information.

A first wireless communication device for wireless communication is described. The first wireless communication device may include a processing system that includes processor circuitry and memory circuitry that stores code. The processing system may be configured to cause the first wireless communication device to transmit a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and receive a set of packets of the traffic flow associated with the holographic communications according to an encoding layer, of a set of multiple encoding layers that correspond to a layered encoding scheme at the second wireless communication device, based on the congestion information.

Another first wireless communication device for wireless communication is described. The first wireless communication device may include means for transmitting a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and means for receiving a set of packets of the traffic flow associated with the holographic communications according to an encoding layer, of a set of multiple encoding layers that correspond to a layered encoding scheme at the second wireless communication device, based on the congestion information.

A non-transitory computer-readable medium storing code for wireless communication is described. The code may include instructions executable by one or more processors to transmit a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and receive a set of packets of the traffic flow associated with the holographic communications according to an encoding layer, of a set of multiple encoding layers that correspond to a layered encoding scheme at the second wireless communication device, based on the congestion information.

A method for wireless communication by a first wireless communication device is described. The method may include transmitting information associated with a layered encoding scheme at the first wireless communication device in association with holographic communications between a set of multiple wireless communication devices including the first wireless communication device, transmitting a set of packets of a traffic flow that is associated with the holographic communications, where the set of packets is associated with a set of multiple encoding layers that correspond to the layered encoding scheme at the first wireless communication device, and receiving a report that indicates a selection, at an application server associated with the holographic communications, of a respective encoding layer of the set of multiple encoding layers on a per-destination basis.

A first wireless communication device for wireless communication is described. The first wireless communication device may include a processing system that includes processor circuitry and memory circuitry that stores code. The processing system may be configured to cause the first wireless communication device to transmit information associated with a layered encoding scheme at the first wireless communication device in association with holographic communications between a set of multiple wireless communication devices including the first wireless communication device, transmit a set of packets of a traffic flow that is associated with the holographic communications, where the set of packets is associated with a set of multiple encoding layers that correspond to the layered encoding scheme at the first wireless communication device, and receive a report that indicates a selection, at an application server associated with the holographic communications, of a respective encoding layer of the set of multiple encoding layers on a per-destination basis.

Another first wireless communication device for wireless communication is described. The first wireless communication device may include means for transmitting information associated with a layered encoding scheme at the first wireless communication device in association with holographic communications between a set of multiple wireless communication devices including the first wireless communication device, means for transmitting a set of packets of a traffic flow that is associated with the holographic communications, where the set of packets is associated with a set of multiple encoding layers that correspond to the layered encoding scheme at the first wireless communication device, and means for receiving a report that indicates a selection, at an application server associated with the holographic communications, of a respective encoding layer of the set of multiple encoding layers on a per-destination basis.

A non-transitory computer-readable medium storing code for wireless communication is described. The code may include instructions executable by one or more processors to transmit information associated with a layered encoding scheme at the first wireless communication device in association with holographic communications between a set of multiple wireless communication devices including the first wireless communication device, transmit a set of packets of a traffic flow that is associated with the holographic communications, where the set of packets is associated with a set of multiple encoding layers that correspond to the layered encoding scheme at the first wireless communication device, and receive a report that indicates a selection, at an application server associated with the holographic communications, of a respective encoding layer of the set of multiple encoding layers on a per-destination basis.

A method for wireless communication by an application server is described. The method may include obtaining a message that includes a set of transcoding parameters corresponding to a traffic flow associated with holographic communications between a set of multiple wireless communication devices, obtaining a feedback message that includes congestion information pertaining to the traffic flow, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, obtaining a first set of packets of the traffic flow that is encoded according to a first coding rate, and outputting a second set of packets that corresponds to the first set of packets in accordance with a selective re-encoding operation, at the application server, of the first set of packets on a per-destination basis, where the selective re-encoding operation is based on the set of transcoding parameters corresponding to the traffic flow and the congestion information.

An application server for wireless communication is described. The application server may include a processing system that includes processor circuitry and memory circuitry that stores code. The processing system may be configured to cause the application server to obtain a message that includes a set of transcoding parameters corresponding to a traffic flow associated with holographic communications between a set of multiple wireless communication devices, obtain a feedback message that includes congestion information pertaining to the traffic flow, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, obtain a first set of packets of the traffic flow that is encoded according to a first coding rate, and output a second set of packets that corresponds to the first set of packets in accordance with a selective re-encoding operation, at the application server, of the first set of packets on a per-destination basis, where the selective re-encoding operation is based on the set of transcoding parameters corresponding to the traffic flow and the congestion information.

Another application server for wireless communication is described. The application server may include means for obtaining a message that includes a set of transcoding parameters corresponding to a traffic flow associated with holographic communications between a set of multiple wireless communication devices, means for obtaining a feedback message that includes congestion information pertaining to the traffic flow, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, means for obtaining a first set of packets of the traffic flow that is encoded according to a first coding rate, and means for outputting a second set of packets that corresponds to the first set of packets in accordance with a selective re-encoding operation, at the application server, of the first set of packets on a per-destination basis, where the selective re-encoding operation is based on the set of transcoding parameters corresponding to the traffic flow and the congestion information.

A non-transitory computer-readable medium storing code for wireless communication is described. The code may include instructions executable by one or more processors to obtain a message that includes a set of transcoding parameters corresponding to a traffic flow associated with holographic communications between a set of multiple wireless communication devices, obtain a feedback message that includes congestion information pertaining to the traffic flow, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow, obtain a first set of packets of the traffic flow that is encoded according to a first coding rate, and output a second set of packets that corresponds to the first set of packets in accordance with a selective re-encoding operation, at the application server, of the first set of packets on a per-destination basis, where the selective re-encoding operation is based on the set of transcoding parameters corresponding to the traffic flow and the congestion information.

In some examples of the method, application servers, and non-transitory computer-readable medium described herein, outputting the second set of packets may include operations, features, means, or instructions for outputting a first coded version of the second set of packets that may be encoded according to the first coding rate, where a first destination of the first coded version of the second set of packets may be a third wireless communication device of the set of multiple wireless communication devices and outputting a second coded version of the second set of packets that may be encoded according to a second coding rate different than the first coding rate based on the set of transcoding parameters and the congestion information, where a second destination of the second coded version of the second set of packets may be the first wireless communication device.

In some examples of the method, application servers, and non-transitory computer-readable medium described herein, the second coding rate may be lower than the first coding rate.

A method for wireless communication by a first wireless communication device is described. The method may include transmitting a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and receiving a set of packets of the traffic flow according to a coding rate, of a set of multiple coding rates that correspond to a selective re-encoding operation associated with the holographic communications, based on the congestion information.

A first wireless communication device for wireless communication is described. The first wireless communication device may include a processing system that includes processor circuitry and memory circuitry that stores code. The processing system may be configured to cause the first wireless communication device to transmit a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and receive a set of packets of the traffic flow according to a coding rate, of a set of multiple coding rates that correspond to a selective re-encoding operation associated with the holographic communications, based on the congestion information.

Another first wireless communication device for wireless communication is described. The first wireless communication device may include means for transmitting a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and means for receiving a set of packets of the traffic flow according to a coding rate, of a set of multiple coding rates that correspond to a selective re-encoding operation associated with the holographic communications, based on the congestion information.

A non-transitory computer-readable medium storing code for wireless communication is described. The code may include instructions executable by one or more processors to transmit a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow and receive a set of packets of the traffic flow according to a coding rate, of a set of multiple coding rates that correspond to a selective re-encoding operation associated with the holographic communications, based on the congestion information.

A method for wireless communication by a first wireless communication device is described. The method may include transmitting, in association with holographic communications between a set of multiple wireless communication devices including the first wireless communication device, a message that includes a set of transcoding parameters corresponding to a traffic flow associated with the holographic communications, transmitting a set of packets of the traffic flow that is encoded according to a first coding rate, and receiving a report that indicates a result of a selective re-encoding operation, at an application server associated with the holographic communications, of the set of packets on a per-destination basis.

A first wireless communication device for wireless communication is described. The first wireless communication device may include a processing system that includes processor circuitry and memory circuitry that stores code. The processing system may be configured to cause the first wireless communication device to transmit, in association with holographic communications between a set of multiple wireless communication devices including the first wireless communication device, a message that includes a set of transcoding parameters corresponding to a traffic flow associated with the holographic communications, transmit a set of packets of the traffic flow that is encoded according to a first coding rate, and receive a report that indicates a result of a selective re-encoding operation, at an application server associated with the holographic communications, of the set of packets on a per-destination basis.

Another first wireless communication device for wireless communication is described. The first wireless communication device may include means for transmitting, in association with holographic communications between a set of multiple wireless communication devices including the first wireless communication device, a message that includes a set of transcoding parameters corresponding to a traffic flow associated with the holographic communications, means for transmitting a set of packets of the traffic flow that is encoded according to a first coding rate, and means for receiving a report that indicates a result of a selective re-encoding operation, at an application server associated with the holographic communications, of the set of packets on a per-destination basis.

A non-transitory computer-readable medium storing code for wireless communication is described. The code may include instructions executable by one or more processors to transmit, in association with holographic communications between a set of multiple wireless communication devices including the first wireless communication device, a message that includes a set of transcoding parameters corresponding to a traffic flow associated with the holographic communications, transmit a set of packets of the traffic flow that is encoded according to a first coding rate, and receive a report that indicates a result of a selective re-encoding operation, at an application server associated with the holographic communications, of the set of packets on a per-destination basis.

### BRIEF DESCRIPTION OF THE DRAWINGS

FIG. 1 shows an example of a wireless communication system.

FIG. 2 shows an example of a wireless communication system that supports coding rate control for holographic communications.

FIGS. 3A and 3B show examples of process flows that support coding rate control for holographic communications.

FIG. 4 shows an example of a process flow associated with layered encoding that supports coding rate control for holographic communications.

FIG. 5 shows an example of a process flow associated with transcoding that supports coding rate control for holographic communications.

FIG. 6 shows an example of a process flow associated with explicit congestion notification (ECN) marking removal that supports coding rate control for holographic communications.

FIG. 7 shows a block diagram of a processing system that supports coding rate control for holographic communications.

FIG. 8 shows a diagram of a system including a device that supports coding rate control for holographic communications.

FIG. 9 shows a block diagram of a processing system that supports coding rate control for holographic communications.

FIG. 10 shows a diagram of a system including a device that supports coding rate control for holographic communications.

FIGS. 11-16 show flowcharts illustrating methods that support coding rate control for holographic communications.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support holographic communications between two or more users. Holographic communications may refer to technologies that support the transmission of three-dimensional (3D) images by one user to one or more other users (and their corresponding wireless communication devices), enabling the reproduction of the 3D images as a realistic representation of an individual and/or objects, which may enable interactions with such individuals and objects as if they were physically present. For example, holographic communications may include video capture via a user equipment (UE) (and/or one or more peripheral devices), where corresponding video frames (e.g., including multiple packets) may be transmitted to an application server via one or more RATs (such as via a 5G or 6G system, among other examples). The video frames may be received by other UEs (and/or peripheral devices) included in the holographic communications session, which may be rendered and presented to a user.

In some cases, wireless communication systems supporting holographic communications may implement a selective forwarding unit (SFU) architecture. An SFU may be an example of a media server or other type of server that may be configured to support, for example, group calls, videoconferencing (e.g., multi-party conferencing), and live broadcasts, among other examples. In accordance with the SFU architecture, an application server may forward (e.g., immediately forward) frames associated with the holographic communications (e.g., audio and video streams) to each of one or more other UEs. In such examples, each UE may receive the frames of all other UEs, and the frames may be used for scene rendering and display (e.g., via a headset or one or more other peripheral devices). As an example, for each time interval (e.g., for each 1/frame per second (fps)) of a holographic communications session (e.g., a call) including N users (e.g., UEs, devices), each user may transmit one video frame (e.g., a data frame) to the application server, and each user may also receive N-1 video frames from the application server.

Some wireless communication systems may further support one or more congestion indications (e.g., explicit congestion notification (ECN) markings) between different wireless communication devices. For example, a congestion condition for a traffic flow may be determined (e.g., by a RAN), and uplink and/or downlink packets may have ECN markings added (e.g., at the Internet Protocol (IP) layer) to indicate the congestion. In some cases, the network may send such packets including the ECN markings to a UE (e.g., in the downlink) or to a user plane function (UPF) (e.g., in the uplink). Additionally, or alternatively, the congestion may be detected for an uplink/downlink flow, and the network may provide congestion information to a UPF. The UPF may accordingly include ECN markings for uplink and downlink packets of the flow (e.g., at the IP layer). In any case, when ECN markings are identified by a wireless communication device associated with the congested flow, the wireless communication device may transmit feedback (e.g., ECN feedback) indicating, for example, information about the congestion and/or packet loss. Further, after receiving the ECN feedback, a transmitting wireless communication device associated with the traffic flow may perform rate adaptation, for example, to mitigate the effects of the congestion.

In the example of holographic communications (such as with systems that implement the SFU architecture), a first user (e.g., a first UE) may receive packets with ECN markings and may transmit (via out-of-band signaling or via user data) ECN feedback to the application server. The ECN feedback may include an identifier (ID) corresponding to a second user (e.g., a second UE) that is a source of the packets. In accordance with receiving the ECN feedback including the ID of the second user, the application server may transmit the ECN feedback to the second user. The second user may receive the ECN feedback and perform rate control, such as to reduce a coding rate of packets from the second user. Such rate control mechanisms, however, may result in data rates being controlled by a worst link condition across a set of (e.g., all) users in a holographic communications session. For example, a third user may receive packets sourced from the second user without ECN markings, such that the third user may experience greater throughput without rate control at the second user (with the third user potentially not experiencing much gain in terms of packet reliability due to the third user having a strong link condition that reliably supports relatively higher coding rates). Thus, some systems that support holographic communications (such as systems that implement the SFU architecture) may benefit from additional coding rate flexibility for packet transmissions to various users in a holographic communications session.

Aspects of the subject matter described in this disclosure relate to coding rate control for holographic communications. Some aspects more specifically relate to an encoding layer selection, from a set of encoding layers associated with a set of packets, at an application server associated with a holographic communications session on a per destination basis. For example, a transmitting device (e.g., a first user that is a source of a set of packets) may encode a set of packets in accordance with a set of encoding layers and transmit multiple coded versions (each coded version corresponding to a respective encoding layer of the set of encoding layers) of the set of packets to the application server. The application server may select a respective coded version of the set of packets for transmission to each other device associated with the holographic communications session (e.g., each of the other N-1 users on the call). For example, the application server may output a first coded version of the set of packets (associated with a first encoding layer of the set of encoding layers) to a first receiving device and output a second coded version of the set of packets (associated with a second encoding layer of the set of encoding layers) to a second receiving device. In some aspects, the application server may select an encoding layer (or, equivalently, a coded version of the set of packets) to use for a packet transmission to a device associated with the holographic communications session in accordance with a presence of ECN feedback from the device. For example, if the application server receives ECN feedback from a device, the application server may select an encoding layer associated with a relatively lower coding rate for the device. By way of further example, if the application server does not receive ECN feedback from a device, the application server may select an encoding layer associated with a relatively higher (e.g., highest) coding rate for the device.

Some additional, or alternative, aspects more specifically relate to a selective re-encoding operation at an application server associated with a holographic communications session on a per destination basis. For example, a transmitting device (e.g., a first user that is a source of a set of packets) may indicate a set of transcoding parameters to the application server and the application server may selectively re-encode a set of packets from the transmitting device using the set of transcoding parameters on a per destination basis. In such examples, the application server may output different coded versions of the set of packets to different devices associated with the holographic communications session (e.g., each of the other N-1 users on the call). For example, the application server may output a first coded version of the set of packets to a first receiving device output a second coded version of the set of packets to a second receiving device. The first coded version of the set of packets may be associated with an absence of re-encoding at the application server and the second coded version of the set of packets may be associated with a re-encoding at the application server. In some aspects, the application server may select (e.g., determine) whether to perform re-encoding for a packet transmission to a device associated with the holographic communications session in accordance with a presence of ECN feedback from the device. For example, if the application server receives ECN feedback from a device, the application server may select to perform re-encoding (e.g., to reduce a coding rate of the set of packets). By way of further example, if the application server does not receive ECN feedback from a device, the application server may select to not perform re-encoding (e.g., to maintain a coding rate of the set of packets as received from the transmitting device).

Particular aspects of the subject matter described in this disclosure can be implemented to realize one or more of the following potential advantages. In some examples, by selectively adjusting a coding rate of a set of packets on a per destination basis, the application server may dynamically adapt a coding rate used for a transmission to a given user in accordance with the specific link conditions experienced by that user. In accordance with dynamically adapting the coding rate on a per destination basis, the application server may balance packet reliability and packet throughput at each device associated with the holographic communications session in accordance with the link conditions experienced by that device, which may support greater user experience associated with the holographic communications session. Additionally, by supporting signaling mechanisms to inform a selection of an encoding layer from a set of available encoding layers or to inform a selective re-encoding operation at the application server, the application server and the devices associated with the holographic communications session may leverage greater coordination capabilities to more comprehensively coordinate regarding which coding rates various devices are using, which may inform encoding decisions at a transmitting device. In accordance with such aspects, the described techniques may be further implemented to realize higher data rates, greater system capacity, and greater spectral efficiency, among other benefits.

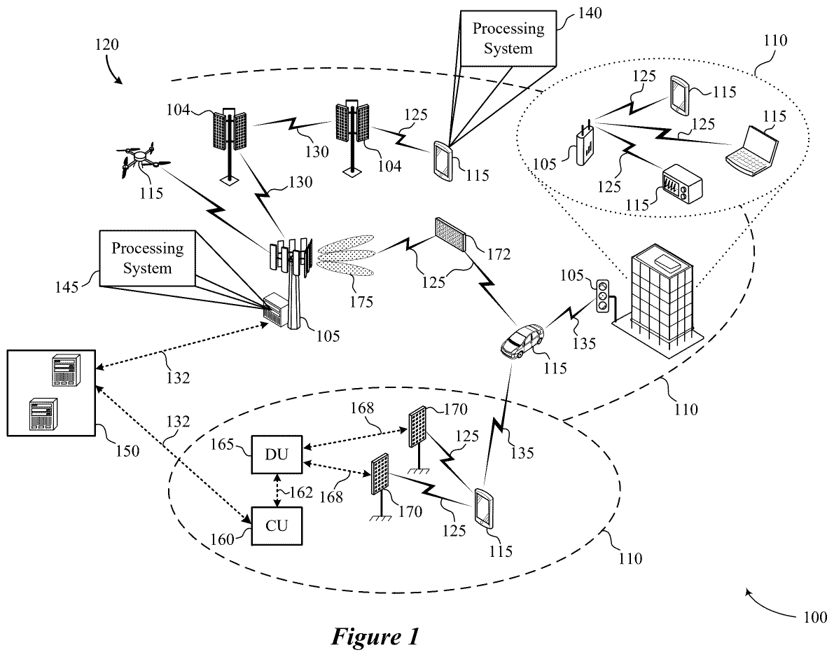

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some aspects, communication between network entities 105 may be supported using a backhaul link 132 (such as an X2, Xn, or other interface) either directly (such as directly between network entities 105) or indirectly (such as via a core network 150). In some aspects (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some aspects, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for coding rate control for holographic communications. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support coding rate control for holographic communications, which may enable an application server to route packets to each of various receiving devices with a respective coding rate (e.g., depending on specific link conditions at that receiving device). For example, an application server associated with holographic communications may support an encoding layer selection or a selective re-encoding operation, or both, to dynamically provide different coded versions of a same set of packets to various receiving devices in a holographic communications session (e.g., on a holographic communications call).

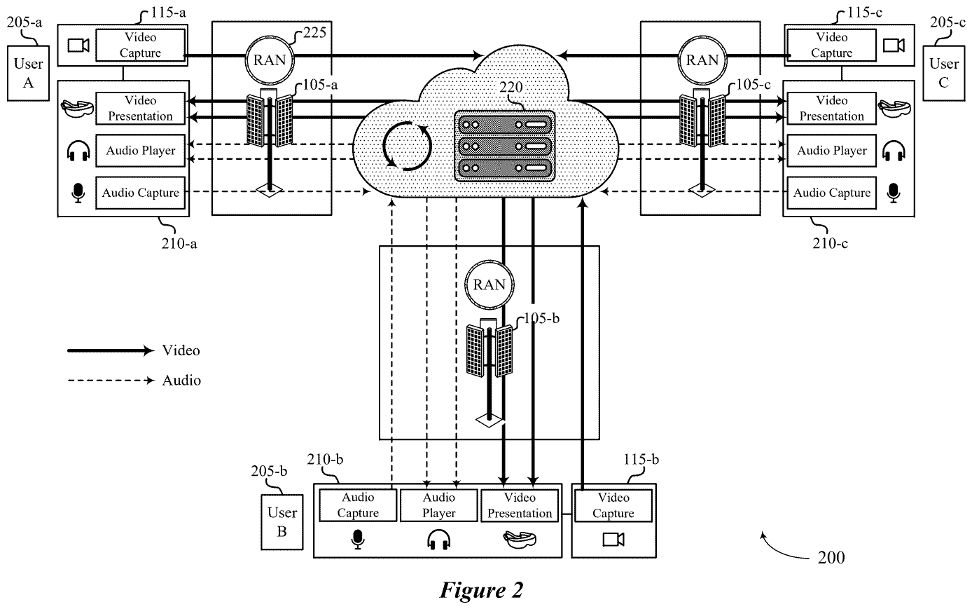

FIG. 2 shows an example of a wireless communication system 200 that supports coding rate control for holographic communications. The wireless communication system 200 may implement, or be implemented by, one or more aspects of the wireless communication system 100. In some aspects, the wireless communication system 200 may support techniques for the coordination of holographic communications between wireless communication devices (e.g., users, UEs 115, or any other devices capable of wireless signaling).

Holographic communications may refer technologies that enable the transmission of 3D images between users, allowing for the realistic representation and interaction with individuals or objects as if they were physically present. Such technology may leverage aspects of holography in which 3D images are created by recording light patterns and reconstructing the light patterns. Some holographic communications techniques may include, for example, processes for 3D image capture and reconstruction, where cameras and/or sensors are used to capture 3D information of a subject, including depth, texture, and color. Data associated with the 3D information may be transmitted and reconstructed using holographic displays and/or projectors at one or more receiving devices. Based on the rendered information, holographic communications may provide a sense of physical presence for users.

As such, holographic communications may be beneficial in various applications and industries. For example, holographic communications may be utilized for virtual meetings, teleconferences, and collaborative environments in which spatial awareness and the ability to perceive gestures and expressions in 3D are impactful (e.g., valued or appreciated by the users). Moreover, holographic communications may provide enhancements to various fields, including, for example, business and telepresence (e.g., for immersive and effective remote meetings, presentations, and conferences), entertainment and media (e.g., providing enhanced forms of viewer engagement and interactive experiences), education and training (e.g., providing engaging and interactive learning experiences, such as virtual classrooms and simulations), healthcare (e.g., telemedicine and remote consultations with a more realistic representation of patients and/or medical data), and technology development (e.g., development of computational power, bandwidth, and display technologies), to name a few. In some examples, holographic communications may involve two or more users, and the data associated with the holographic communications may be represented as holograms in XR scenes (where XR may include or be associated with virtual reality (VR), augmented reality (AR), mixed reality (MR), and/or similar technologies).

The wireless communication system 200 illustrates a system that supports holographic communications between multiple users, where each user may be associated with one or more wireless communication devices, such as a UE 115 and/or one or more devices 210 (e.g., one or more peripheral devices). As an example, a first user 205-a (e.g., user A) may be associated with a first UE 115-a and/or one or more devices 210-a (e.g., peripheral devices), where the UE 115-a and/or the devices 2100-a may be an example of a UE 115 described with reference to FIG. 1. Similarly, a second user 205-b (e.g., user B) may be associated with a second UE 115-b and one or more devices 210-b (e.g., peripheral devices), and a third user 205-c (e.g., user C) may be associated with a third UE 115-c and one or more devices 210-c (e.g., peripheral devices). Some aspects of the present disclosure may be described with reference to a user transmitting/receiving packets or performing some operations, and it will be clear to a person having ordinary skill in the art that such descriptions refer to the devices 210 and/or UEs 115 associated with a user that transmit/receive packets or perform some operations in association with one or more network entities 105 and RATs. For example, a user transmitting one or more packets is understood to mean that a UE 115 and/or one or more devices 210 associated with the user transmit the one or more packets, which may be signaled via one or more network entities 105 that operate in accordance with one or more RATs.

The one or more devices 210 associated with each user may include, for example, one or more headsets, booths, tables, projectors, displays, speakers, and/or other types of devices and components that support and/or are configured for rendering of audio and/or video associated with holographic communications. Such devices 210 may be portable or unportable. As an illustrative example, the one or more devices 210-a may include a headset display that supports video presentation, speakers that support audio presentation, and a microphone that supports audio capture. Further, the UE 115-a may support video capture associated with the holographic communications. In some cases, the UE 115-a may be coupled with (e.g., via a wireless connection, via a wired connection, or both) the one or more device 210-a. In some cases, a UE 115-a may be capable of performing the operations associated with the holographic communications. For example, the UE 115-a may be capable of video capture, video rendering and presentation, audio playback, and/or audio capture. As such, the techniques, functions, and capabilities described herein with reference to a UE 115 may similarly apply to the one or more devices 210, and vice versa. In some examples, one or more UEs 115 and/or the one or more devices 210 may be associated with an application client for the holographic communications, where the application client may communicate sets of frames (where each frame may be associated with one or multiple packets) with the application server.

In some examples, data associated with the UEs 115 and the one or more devices 210 may be communicated via one or more network entities 105 (e.g., a network entity 105-a, a network entity 105-b, a network entity 105-c), which may each be an example of a network entity 105 described with reference to FIG. 1. As an example, the UE 115-a may utilize one or more application to capture video associated with the holographic communications (e.g., using one or more cameras), and the UE 115-a may transmit a set of frames (e.g., video frames, data frames) to an application server 220 via a network entity 105-a. Similarly, the one or more devices 210-a may exchange signaling with the application server 220 via the network entity 105-a. For example, a headset that supports video presentation may receive a set of frames (e.g., video frames, which may be referred to as data frames) from the application server 220 that may be rendered for the holographic communications, and an audio player may receive a set of frames (e.g., audio frames) from the application server 220 that may provide corresponding audio for the holographic communications. In any case, the network entity 105-a may be associated with a RAN 225 (such as a 5G NR network) and may operate in accordance with one or more RATs associated with the RAN 225. In some examples, a UE 115 may receive the frames from the application server 220, and the UE 115 may provide the frames to the one or more devices 210, or the UE 115 may be configured to render audio and video using the received frames.

In some aspects, the wireless communication system 200 may implement an SFU architecture. An SFU may be an example of a media server or other type of server that may be configured to support group calls, videoconferencing (e.g., multi-party conferencing), and live broadcasts, among other examples. In the SFU architecture, every connected device (e.g., each client device) may transmit a set of outgoing media streams to a server (e.g., an application server 220), and the set of streams is forwarded to every other device (or to at least one or more other devices) by the SFU. As an example, an application server 220 (e.g., associated with the SFU architecture) may forward (e.g., immediately forward) frames associated with the holographic communications to each UE 115 (e.g., UE 115-a, UE 115-b, UE 115-c) and/or the one or more devices 210 (e.g., devices 210-a, devices 210-b, or devices 210-c). In such examples, each UE 115 may receive the frames of all other UEs 115, and the frames may be used for scene rendering and display by the UE 115 and/or the one or more devices 210 (e.g., via a headset or one or more other peripheral devices). Here, for each time interval (e.g., each 1/fps, where fps may be, for example, 60 fps) of a holographic communications session including N users, each UE 115 may transmit one frame (e.g., video frame, data frame) to the application server, and each UE 115 (and/or one or more devices 210) may receive N-1 frames (e.g., N-1 video frames) from the application server 220. Put differently, frames may be transmitted periodically to the application server 220, and the application server 220 may forward the frames to all other users (e.g., UEs 115 and/or devices 210) immediately. The application server 220 may be the SFU, may be a component of the SFU, or may include the SFU.

Additionally, the wireless communication system 200 may support congestion indications (e.g., ECN markings) between different devices. For example, ECN markings may be used to help identify and control congestion (e.g., congestion causing delays in packet transmission and/or delivery, congestion resulting in packet loss, or the like) in the wireless communication system 200, and corresponding ECN feedback may help to reduce packet loss and delays. An ECN marking may refer to one or more bits (e.g., one bit or two bits, among other examples) included in a packet header (e.g., an IP header) to indicate congestion. For example, a congestion condition for a traffic flow may be determined (e.g., by a RAN 225), and uplink and/or downlink packets may have ECN markings added (e.g., at the IP layer) to indicate the congestion, where the RAN 225 may send such packets including the ECN markings to either a UE 115 (e.g., in the downlink) or to a UPF (e.g., in the uplink). Additionally, or alternatively, the congestion may be detected for an uplink/downlink flow and the RAN 225 may indicate congestion information to a UPF. The UPF may than include ECN markings for uplink and downlink packets of the flow (e.g., at the IP layer). In some examples, one or more techniques may be used to detect the congestion, such as an active queue management (AQM) detection technique, among other examples. ECN techniques may be used for applications such as cloud gaming, AR/VR, and real-time video (such as with holographic communications), among other examples. In any case, when ECN markings are identified by a receiving device (e.g., a UE 115) associated with the congested flow, the device may transmit feedback (e.g., ECN feedback) indicating, for example, information about the congestion and/or packet loss. After receiving the ECN feedback, the transmitting device may perform rate adaptation to mitigate the effects of such congestion.

Some systems that support holographic communications (such as in systems that implement the SFU architecture) may further support techniques to enable ECN feedback to be provided to respective UEs 115 involved in a holographic communications session, which may enable some UEs 115 to perform rate adaptation to mitigate such congestion. In some cases, the ECN feedback may be signaled from a UE 115 to one or more UEs 115 of the holographic communications session. For example, a receiving UE 115 may detect congestion for a traffic flow with another UE 115 (e.g., based on a presence of ECN markings), and the receiving UE 115 may transmit an ECN feedback message via out-of-band signaling to the application server 220. The application server 220 may send the feedback to the other UE 115 (or other UEs 115) that transmitted the packets associated with the traffic flow. In such cases, the ECN feedback message may include an ID of the transmitting UE 115, which the application server 220 may use for notifying the transmitting UE 115 of the congestion (e.g., via the forwarded ECN feedback).

Additionally, or alternatively, the congestion may be detected for downlink packets of a traffic flow, and the receiving UE 115 may transmit the ECN feedback message to the application server 220 via in-band signaling, where the ECN feedback message may include an ID of the transmitting UE 115 and may be forwarded by the application server 220 to each other UE 115 included in the holographic communications session. For example, the ECN feedback message may be forwarded by the application server 220 as a holographic communications message from the receiving UE 115, and the application server 220 may forward the ECN feedback message to the transmitting UE 115 (while removing the ECN feedback information for data forward to each other UE 115 in the holographic communication session). The transmitting UE 115 may check the ID included in the ECN feedback message and may perform rate adaptation (e.g., rate reduction) based on the congestion corresponding to the traffic flow of that UE 115 (and as indicated by the ECN feedback message). In some examples, the ECN feedback message may include the respective IDs of one or more UEs 115, which may enable multiple UEs 115 to be aware of the congestion affecting one or more flows of the holographic communications session. For example, a UE 115 receiving the ECN feedback may have an ID that is the same as an ID included in the ECN feedback message, and that UE 115 may perform rate reduction, whereas one or more other UEs 115 having different IDs may ignore the ECN feedback.

In some systems, however, such techniques to enable ECN feedback to be provided to respective UEs 115 involved in a holographic communications session may result in data rates (e.g., coding rates) being driven by (e.g., controlled by or influenced by) a worst link condition across a set of UEs 115 (e.g., users or clients) in the holographic communications session. For example, in a four person holographic call including user A, user B, user C, and user D, users B, C, and D may experience relatively good conditions (e.g., channel or link conditions that satisfy a threshold signal quality, congestion, or reliability metric) and user A may experience relatively poor conditions (e.g., channel or link conditions that fail to satisfy the threshold signal quality, congestion, or reliability metric). In such examples, a serving RAN of user A may detect congestion and mark ECN in at least one of the downlink flows to user A, such as a downlink flow issued by, such as sourced from, user D. In accordance with detecting the congestion, user A may insert or otherwise transmit (e.g., indicate, output, or provide) an ECN feedback indication for user D. Upon reception of the ECN feedback, user D may reduce a data rate (e.g., a coding rate). Accordingly, user A may receive the traffic flow from user D with a lower data rate, which may be an expected behavior and increase a packet reliability for user A. Users B and C, however, also receive the traffic flow from user D with the lower data rate, even though users B and C experience relatively good conditions, which may result in a degradation of user experience at users B and C (as packet reliability is not an issue at users B and C, such that users B and C may expect higher throughput and would have otherwise experienced higher throughput if not for the poor conditions experienced by user A). Such issues of a worst link condition hindering or limiting a performance of multiple users in the holographic communications session may become worse as the quantity of users in the holographic communications session increases (e.g., as the likelihood of at least one user experiencing poor conditions may increase as the quantity of users in the holographic communications session increases).

In some aspects of the present disclosure, various wireless communication devices (e.g., UEs 115, devices 210, network entities 105, the application server 220) support coding rate control for holographic communications, which may enable the application server 220 to route packets to each of various receiving devices with a respective coding rate (e.g., depending on specific link conditions at that receiving device). For example, the application server 220 may support an encoding layer selection or a selective re-encoding operation, or both, to dynamically provide different coded versions of a same set of packets to various receiving devices in a holographic communications session (e.g., on a holographic communications call). In this way, the application server 220 may provide a first coded version of a set of packets to users B and C that is associated with a relatively higher coding rate and may provide a second coded version of the set of packets to user A that is associated with a relatively lower coding rate.

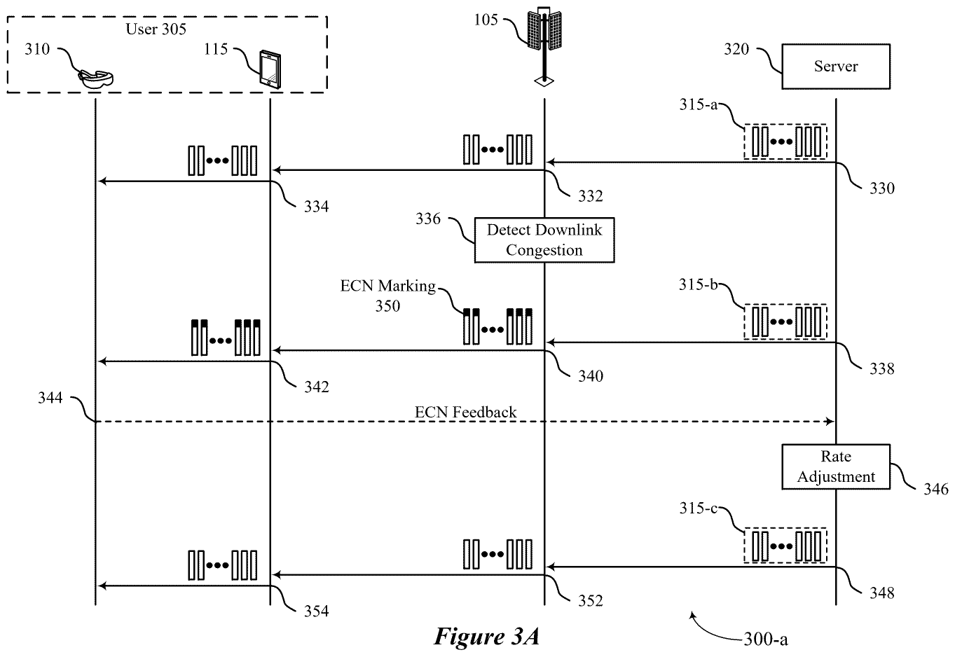

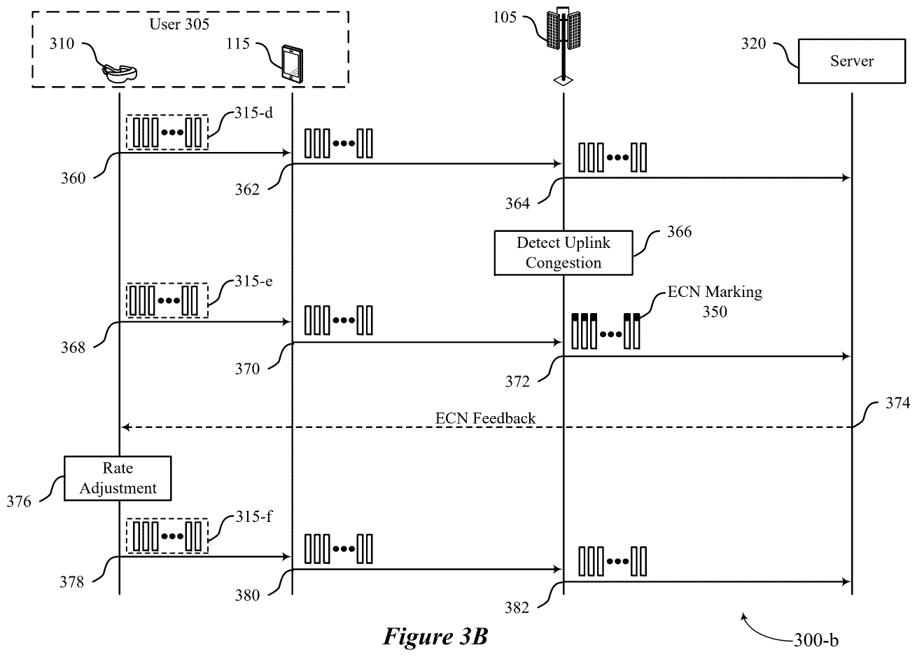

FIGS. 3A and 3B show examples of a process flow 300-a and a process flow 300-b, respectively, that support coding rate control for holographic communications. The process flow 300-a and the process flow 300-b may each implement or be implemented by aspects of the wireless communication system 100 and the wireless communication system 200. For example, the process flow 300-a and the process flow 300-b may illustrate the transmission and reception of one or more packets 315 by one or more wireless communication devices associated with a user 305 (e.g., a UE 115 and/or one or more devices 310 (such as one or more peripheral devices)) that support holographic communications. Additionally, the process flows 300-a and 300-b include a network entity 105 that may be an example of the network entities 105 described with reference to FIGS. 1 and 2. The process flow 300-a and the process flow 300-b may each include an application server 320, which may be an example of the application server 220 described with reference to FIG. 2. In some aspects, the process flow 300-a and the process flow 300-b may each support various techniques described herein for enabling coding rate adjustment decisions at the application server 320 as part of forwarding packets between devices (e.g., users) associated with holographic communications.

The packets 315 communicated by each UE 115 may, additionally, or alternatively, be transmitted and/or received by one or more peripheral devices, which may be examples of the corresponding devices described with reference to FIGS. 1 and 2. As an example, a UE 115 may be coupled with (e.g., via a wired link or a wireless link, or both) or more peripheral devices that may each support techniques and functions associated with holographic communications (such as video capture, video presentation, audio capture, audio playback, among other examples). Although sometimes not shown, each UE 115 may communicate (e.g., transmit and/or receive) signaling with the application server 320 via one or more network entities (such as a network entity 105 described with reference to FIGS. 1 and 2). Additional UEs 115 (not shown) may likewise exchange set of packets 315 via the application server 320, as a holographic communications session may include multiple users, and the quantity of UEs 115 (and users) shown in the examples provided herein should not be considered limiting to the scope of the claims or the disclosure.

The process flows 300-a and 300-b may each illustrate examples of techniques with which one or more ECN markings 350 are included in one or more packets 315 of a traffic flow. ECN techniques may enable the reporting of congestion conditions to an application client, for example, via the user plane, which may facilitate rate adaptation at the application layer. In some cases, a network entity 105 associated with a RAN (e.g., an NG-RAN) may be responsible for detecting congestion, and the RAN or the UPF may mark packets 315 with an ECN marking 350. For example, the network entity 105 may detect congestion and perform ECN marking for uplink and downlink in an IP layer for the received packets. The network entity 105 may send the packets to the UE 115 (e.g., for downlink) and UPF (e.g., for uplink). Alternatively, the network entity 105 may detect the congestion for an uplink/downlink flow and indicate the latest congestion information to the UPF via a congestion report. Based on the received congestion report, the UPF may perform ECN marking for uplink and downlink in an IP layer for the received packets. It is noted that, while some examples provided herein describe congestion detected by a network entity 105, one or more aspects of the techniques described herein may also apply to cases where congestion is detected or identified by one or more other devices and/or nodes (e.g., congestion may be detected wherever it occurs). As such, the examples provided herein should not be considered limiting to the scope of the claims or the disclosure.

An example of downlink ECN marking techniques is shown by the process flow 300-a of FIG. 3A. For example, at 330, the application server 320 may output a set of packets 315-a of a traffic flow to the network entity 105. Accordingly, the network entity 105 may obtain the set of packets 315-a and, at 332, the network entity 105 may output the set of packets 315-a to a user 305 (e.g., to one or more wireless communication devices of the user 305 including, for example, a UE 115 and/or one or more devices 310 (such as one or more peripheral devices)). In some cases, the UE 115 may receive the set of packets 315-a and, at 334, may transmit the set of packets to the one or more devices 310.

At 336, the network entity 105 may detect congestion (e.g., congestion causing delays in packet transmission and/or delivery, congestion resulting in packet loss, or the like) associated with the transmission of the first set of packets 315-a. In such cases, after the application server outputs another set of packets 315-b at 338, the network entity 105 may include (e.g., add) one or more ECN markings 350 to the received set of packets 315-b. For example, at least one packet of the set of packets 315-b may include an ECN marking 350. At 340, the network entity 105 may output the set of packets 315-b to the UE 115, where the set of packets 315-b received by the UE 115 may include the ECN marking 350. The UE 115 may transmit the set of packets 315-b having the ECN marking 350 to the one or more devices 310 (e.g., to an application client of the one or more devices 310) at 342.

The one or more devices 310 may identify the ECN marking 350 included with the received set of packets 315-b and, at 344, the one or more devices 310 may transmit (e.g., an application client of the one or more devices 310 may output) ECN feedback to the application server 320. In some cases, the ECN feedback may include feedback to the application server 320 (e.g., the source of the set of packets 315-b) about congestion and packet loss of a traffic flow corresponding to the set of packets 315-b. The ECN feedback may be reported to the application server 320, for example, via out-of-band signaling (e.g., using a channel that is different than a channel used for communicating the packets 315).

The application server 320 may obtain the ECN feedback at 344, and the application server 320 may perform rate adjustment (e.g., modifying a data rate) at 346, which may be based on the ECN feedback (e.g., based on information about the downlink congestion and/or packet loss for the corresponding flow). The modified data rate may be used to alleviate the downlink congestion identified by the network entity 105.

At 348, the application server 320 may output a set of packets 315-c using the modified data rate. The set of packets 315-c may be obtained by the network entity 105 and output to the UE 115 at 352. The UE 115 may receive the set of packets 315-c and transmit the set of packets 315-c to the one or more devices 310 at 354.

Further, an illustrative example of uplink ECN marking techniques is shown by the process flow 300-b of FIG. 3B. Here, at 360, the one or more device 310 may transmit (e.g., an application client of the one or more devices 310 may output) a set of packets 315-d to the UE 115. At 362, the UE 115 may transmit the set of packets 315-d to the network entity 105 and, at 364, the network entity may output the set of packets 315-d to the application server 320.

Based on the set of packets 315-d received in the uplink at 362, the network entity 105 may detect congestion associated with the set of packets 315-d at 366. As such, after the one or more devices 310 transmit a next set of packets 315-e to the UE 115 at 368, and when the UE 115 transmits the set of packets 315-e to the network entity 105 at 370, the network entity 105 may include one or more ECN markings 350 with the received set of packets 315-e (e.g., based on the detected congestion). For example, at least one packet of the set of packets 315-e may include the ECN marking 350. At 372, the network entity 105 may output the set of packets 315-e including the ECN marking 350 to the application server 320.

At 372, the application server 320 may obtain the set of packets 315-e including the ECN marking 350, and the application server 320 may, at 374, transmit ECN feedback to the one or more devices 310 (e.g., to the application client of the one or more devices 310). In some examples, the application server 320 may report the ECN feedback to the application client via out-of-band signaling (e.g., via one or more channels different from channels used for the holographic communications).

The one or more devices 310 may receive (e.g., the application client of the one or more devices 310 may obtain) the ECN feedback at 374, and the one or more devices 310 may perform rate adjustment (e.g., modifying a data rate) at 376 based on the ECN feedback. The modified data rate may be used to alleviate the uplink congestion identified by the network entity 105.

At 378, the one or more devices 310 may transmit, to the UE 115, a set of packets 315-f using the modified data rate. The set of packets 315-f may be transmitted from the UE 115 to the network entity 105 at 380, and at 382, the network entity 105 may output the set of packets 315-f to the application server 320.

In some aspects of the present disclosure, various wireless communication devices (e.g., UEs 115, devices, network entities 105, the application server 320) support coding rate control for holographic communications, which may enable the application server 320 to route packets to each of various receiving devices with a respective coding rate (e.g., depending on specific link conditions at that receiving device). For example, the application server 320 may support an encoding layer selection or a selective re-encoding operation, or both, to dynamically provide different coded versions of a same set of packets to various receiving devices in a holographic communications session (e.g., on a holographic communications call). In this way, the application server 320 may provide a first coded version of a set of packets a first receiving device that is associated with a relatively higher coding rate and may provide a second coded version of the set of packets to second receiving device that is associated with a relatively lower coding rate. The application server 320 may provide the second coded version of the set of packets (associated with the relatively lower coding rate) to the second receiving device in accordance with a detection of at least one or at least a threshold quantity of ECN markings in packets transmitted to or from the second receiving device. Further, although sometimes illustrated in the example scenario of a detection of congestion at a receiving RAN node, the described techniques may be applicable to any mechanism for congestion detection at any device, entity, node, or functionality.

In some aspects, to support coding rate control for holographic communications, one or more devices associated with a holographic communications session may support layered encoding or transcoding, or both, to address (e.g., with low latency) varying conditions (e.g., varying channel or link conditions). Layered encoding may involve a server device (e.g., an application server) encoding media into multiple streams, which may be referred to as layers, and an intermediate node transmitting one or more layers that match a current set of conditions. For example, a server may provide a node with a multi-layer encoding of a set of packets and the node may forward, transmit, or otherwise output (for transmission or forwarding) one or more layers (e.g., a subset of the available layers) in accordance with a current set of conditions. The node may forward, transmit, or output the one or more layers to a device, such as a UE 115.

Transcoding may involve a server device (e.g., an application server) encoding media into a stream (e.g., sometimes with an upper limit, maximum, or highest bit rate) and an intermediate node decoding the stream and re-encoding the stream with a bit rate that matches a current set of conditions. For example, a server may provide a highest bit rate encoding to a node and the node may re-encode the stream with a bit rate that is suitable for (e.g., adapted to) the current set of conditions. In some systems, the intermediate node, for either layered encoding or transcoding, may be a network entity 105 (e.g., a gNB), as the network entity 105 may be able to react (with low latency) to varying radio conditions that a UE 115 is experiencing. In some other systems, and in accordance with some example aspects of the present disclosure, a client device (e.g., a UE 115) may encode data and an application server (e.g., the application server 320 may operate as the intermediate node to adapt the transmission to each client device according to a respective set of conditions experienced by that client device.

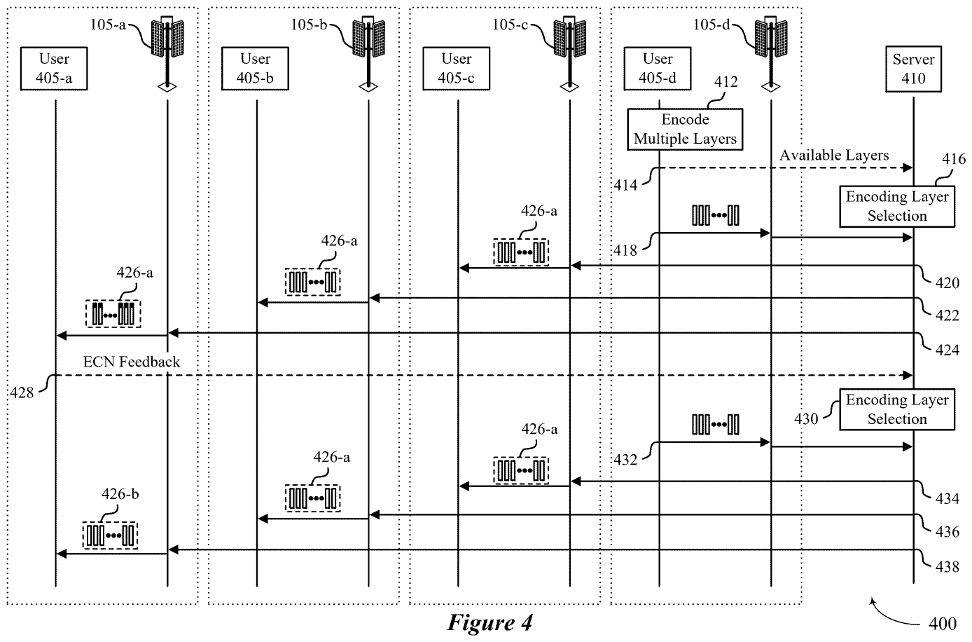

FIG. 4 shows an example of a process flow 400 associated with layered encoding that supports coding rate control for holographic communications. In some examples, the process flow 400 may implement or be implemented by aspects of the wireless communication system 100, the wireless communication system 200, the process flow 300-a, the process flow 300-b, or any combination thereof. For example, the process flow 400 illustrates signaling involving a user 405-a, a network entity 105-a, a user 405-b, a network entity 105-b, a user 405-c, a network entity 105-c, a user 405-d, a network entity 105-d, and an application server 410.

The user 405-a, the user 405-b, the user 405-c, and the user 405-d may each be an example of a user 305 as illustrated by and described with reference to FIGS. 3A and 3B. Each user may be associated with a corresponding UE 115, such that communication between a network entity 105 and a user may be understood as communication between the network entity 105 and a UE 115 corresponding to the user. The network entity 105-a, the network entity 105-b, the network entity 105-c, and the network entity 105-d may each be an example of a network entity 105 as illustrated by and described with reference to FIGS. 1, 2, 3A, and 3B. The application server 410 (e.g., an SFU) may be an example of the application server 220 or the application server 320 as illustrated by and described with reference to FIGS. 2, 3A, and 3B. The application server 410 may be associated with an SFU architecture that is utilized for holographic communications.

In the following description of the process flow 400, the operations between the UEs 115 (e.g., the users), the network entities 105, and the application server 410 may be communicated in a different order than the example order shown, or the operations performed by one or more of the UEs 115, the network entities 105, and the application server 410 may be performed in different orders or at different times. Some operations may also be omitted from the process flow 400, and other operations may be added to the process flow 400. Further, as described herein, aspects of the functions performed by one or more of the UEs 115 may additionally, or alternatively, be performed by one or more other wireless communication devices (e.g., one or more peripheral devices). Further, operations described herein as being performed by a user may be equivalently understood as being performed by a UE 115 associated with the user.

At 412, the user 405-d may encode a set of packets with multiple layers. For example, the user 405-d may encode a set of packets associated with a traffic flow with three layers including a first encoding layer (e.g., associated with a lowest coding rate), a second encoding layer (e.g., associated with an intermediate coding rate), and a third encoding layer (e.g., associated with a highest coding rate). At 414, the user 405-d may transmit, to the application server 410 (and via out-of-band signaling), an indication of the set of available layers associated with the packets from the user 405-d. For example, the user 405-d may indicate that the user 405-d will provide different coded versions of packets according to the first encoding layer, the second encoding layer, and the third encoding layer. In some aspects, each transmitting client may signal (e.g., transmit or indicate, such as via wireless (out-of-band) signaling) to the application server 410 the set of encoding layers that are available, including information that the application server 410 may use to transmit (packets according to) each of such encoding layers. Additionally, or alternatively, each transmitting client may signal (e.g., transmit or indicate, such as via wireless (out-of-band) signaling) to the application server 410 whether that transmitting client utilizes layered encoding.

At 416, the application server 410 may perform an encoding layer selection on a per destination basis associated with packets from the user 405-d. In some aspects, the application server 410 may select to use the third encoding layer (associated with the highest coding rate) for each of the user 405-a, the user 405-b, and the user 405-c. The application server 410 may select the encoding layer associated with the highest coding rate in accordance with a default or initial operation, such as in the absence of information indicating that the user 405-a, the user 405-b, or the user 405-c is experiencing congestion.

At 418, the user 405-d may transmit a set of packets, which the network entity 105-d may receive and provide to the application server 410. In accordance with performing the encoding layer selection, the application server 410 may, at 420, 422, and 424, output a first coded version 426-a (a same coded version) of the set of packets to each of the user 405-c, the user 405-b, and the user 405-a, respectively. The first coded version 426-a of the set of packets may be associated with the third encoding layer selected by the application server 410 at 416.

At 424, the network entity 105-a (e.g., the RAN) associated with the user 405-a may detect congestion and may include one or more ECN markings in the coded packets that are received by the user 405-a. At 428, the user 405-a may send ECN feedback (e.g., a feedback message) to the application server 410 (e.g., via out-of-band signaling) to indicate the congestion to the application server 410. In some examples, the ECN feedback may include an ID corresponding to a source of the packets. For example, the ECN feedback may include an ID that corresponds to the user 405-d (to indicate that the user 405-d was a source of the packets received by the user 405-a with ECN makings). In some aspects, when the application server 410 (e.g., the SFU) receives an ECN feedback from a receiving client device (e.g., the user 405-a) associated with a traffic flow, and if the transmitting client device (e.g., the user 405-d) of the traffic flow utilizes layered encoding, the application server 410 may utilize the ECN feedback to determine (e.g., identify, select, or otherwise ascertain) which one or more encoding layers to transmit to that receiving client device (e.g., for next packets sourced from the indicated transmitting client device).

For example, at 430, the application server 410 may perform another encoding layer selection in accordance with receiving the ECN feedback. In some aspects, the application server 410 may change the layer transmitted to the user 405-a from the third encoding layer (associated with the highest coding rate) to the first encoding layer (associated with the lowest coding rate) in accordance with receiving the ECN feedback from the user 405-a.

At 432, the user 405-d may transmit a next set of packets associated with the traffic flow, which the network entity 105-d associated with the user 405-d may provide to the application server 410. In accordance with performing the encoding layer selection at 430, the application server 410 may, at 434, 436, and 438, output a respective coded version of the set of packets for each of the user 405-c, the user 405-b, and the user 405-a, respectively. In some aspects, the application server 410 may output a first coded version 426-a of the set of packets for the user 405-c and the user 405-b. The first coded version 426-a may be associated with the third encoding layer (associated with the highest coding rate, which the application server 410 may maintain for the user 405-c and the user 405-b in accordance with an absence of ECN feedback from the user 405-c and the user 405-b). In some aspects, the application server 410 may output a second coded version 426-b of the set of packets for the user 405-a. The second coded version 426-b may be associated with the first encoding layer (associated with the lowest coding rate, which the application server 410 may use for the user 405-a in accordance with the received ECN feedback from the user 405-a).

In some aspects, the application server 410 may report, to each transmitting client device (e.g., via out-of-band signaling), the encoding layers that were transmitted in a past time period across a set of (e.g., all) receiving client devices. For example, the application server 410 may report, to the user 405-d, an indication that the first encoding layer was used for packet transmissions to the user 405-a and that the third encoding layer was used for packet transmissions to the user 405-b and the user 405-c. In some aspects, the application server 410 may report full rate control feedback (e.g., ECN L4S feedback, round-trip-time (RTT)). In some aspects, a transmitting client device may use such reported information to update the set of layers that the transmitting client device is encoding. For example, a transmitting client device (e.g., the user 405-d) may cease or stop providing a coded version of a set of packets associated with an encoding layer that the application server 410 is not using for packet transmissions to any receiving client devices or if the application server 410 is using the encoding layer for packet transmissions to less than a threshold quantity of receiving client devices. By way of further example, a transmitting client device (e.g., the user 405-d) may start providing another coded version of a set of packets associated with a new encoding layer in accordance with the application server 410 using encoding layers near an upper most or lower most coding rate of the available coding rates for a threshold quantity of receiving client devices or for a threshold quantity of time, or both.

In some aspects, each transmitting client device may configure (e.g., via one or more messages, such as one or more control messages) the application server 410 with a reporting configuration. In such aspects, the application server 410 may transmit a report including an indication of which encoding layers were transmitted (e.g., used) in a past time period to that transmitting client device in accordance with the reporting configuration. For example, the user 405-d may transmit information indicative of a reporting configuration to the application server 410 (e.g., via out-of-band signaling). A reporting configuration may include, define, indicate, or be associated with a reporting condition (e.g., periodic or event-triggered), a reporting period (if periodic), a triggering event (if event-triggered, and such as a highest layer transmitted has changed since a previous (most recent) report), or any combination thereof.

In addition to ECN feedback messages from receiving client devices, the application server 410 may use other information from the receiving client devices to inform the encoding layer selection performed by the application server 410. In some aspects, for example, each client device (e.g., each of the user 405-a, the user 405-b, the user 405-c, and the user 405-d) may report information related to (e.g., associated with) a current link condition to the application server 410. Such information may include, for example, an indication of one or more suggested encoding layers (e.g., that the client device expects or predicts to be most adapted to the current link conditions experienced by the client device), an upper limit (e.g., a maximum) supported bit rate, one or more measurements of a radio quality (e.g., a reference signal received power (RSRP) metric or a channel quality indicator (CQI) metric, among other examples), a link capacity estimation (LCE), an RTT, or any combination thereof. In some aspects, the client device may report such information to the application server 410 from a modem of the client device via a cross-layer application program interface (API).

In some aspects, the application server 410 may configure (e.g., via one or more messages, such as one or more control messages) a client device (such as each client device) with a reporting configuration associated with such information (e.g., such link condition information). The reporting configuration may include, define, indicate, or be associated with a set of reporting objects (e.g., suggested layers, RSRP, or CQI, among other examples), a list of available layers, a reporting condition (e.g., periodic or event-triggered), a reporting period (if periodic), a triggering event (if event-triggered, and such as the suggested layer(s) having changed since a previous (most recent) report, or an RSRP having changed by a threshold amount X (which may be configurable between the application server 410 and one or more client devices, such as each client device)), or any combination thereof. In some aspects, a client device may transmit a report including such information, and/or may receive a reporting configuration associated with reporting such information, via out-of-band signaling between the client device and the application server 410.

In some aspects, one or more of the devices illustrated by the process flow 400 may support one or more signaling mechanisms to provide encoding layer awareness at the RAN. For example, the RAN may benefit from receiving information indicative of which encoding layers a client device may transmit and/or receive. The RAN may use such information for one or more network operations, such as radio resource management (RRM) (e.g., BWP selection) or for call admission control (CAC). In such aspects, a client device that utilizes layered encoding for a traffic flow may report, to the RAN (e.g., via a transmission to a network entity 105), some information (e.g., a bit rate) associated with the encoding layers that the client device may use for encoding the traffic flow. The client device may transmit the report via RRC signaling (e.g., via UE assistance information (UAI)), a MAC control element (MAC-CE), or via Layer 1 signaling (e.g., uplink control information (UCI)). The report may include a flow ID (e.g., a QoS flow ID, a data radio bearer (DRB) ID) and some additional information, such as a bit rate.

In some aspects, the application server 410 may provide (e.g., output or transmit to) each client device with a list of available encoding layers for each traffic flow that this client device receives. The application server 410 may provide or otherwise indicate the list of available encoding layers for each traffic flow via out-of-band signaling. For example, in accordance with receiving the indication of the available layers associated with the layered encoding at the user 405-d, the application server 410 may forward the indication of the available layers to each of the user 405-c, the user 405-b, and the user 405-a via out-of-band signaling. A client device that receives the information indicative of the encoding layers that are available for a downlink traffic flow may report this information to the RAN. For example, in accordance with receiving the indication of the available layers, each of the user 405-c, the user 405-b, and the user 405-a may transmit (e.g., relay or forward) an indication of the available layers to an associated network entity 105. By way of further example, the user 405-c may transmit the indication of the available encoding layers to the network entity 105-c, the user 405-b may transmit the indication of the available encoding layers to the network entity 105-b, and the user 405-a may transmit the indication of the available encoding layers to the network entity 105-a. The report may be an RRC message (e.g., UAI), a MAC-CE, or L1 signaling (e.g., UCI). The report may include or indicate a list of traffic flows and, for each traffic flow in the list of traffic flows, a flow ID (e.g., a QoS flow ID or a DRB ID) and some additional information, such as a bit rate. In this way, a client device may indicate, to a serving network entity 105, the possible encoding layers (and/or corresponding bit rates) that the client device may receive packets in accordance with.

In accordance with such aspects, the application server 410 may facilitate selective coding for various sets of packets over time on a per destination basis, along with enabling further coordination between devices to provide greater synchronization and more accurate or suitable resource allocation, among other benefits.

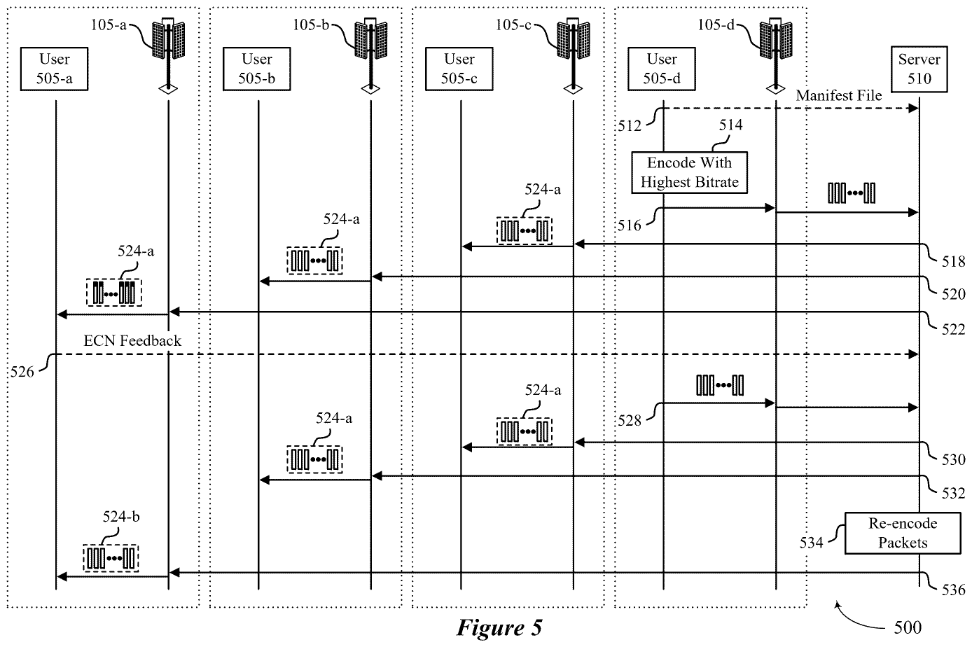

FIG. 5 shows an example of a process flow 500 associated with transcoding that supports coding rate control for holographic communications. In some examples, the process flow 500 may implement or be implemented by aspects of the wireless communication system 100, the wireless communication system 200, the process flow 300-a, the process flow 300-b, the process flow 400, or any combination thereof. For example, the process flow 500 illustrates signaling involving a user 505-a, a network entity 105-a, a user 505-b, a network entity 105-b, a user 505-c, a network entity 105-c, a user 505-d, a network entity 105-d, and an application server 510.

The user 505-a, the user 505-b, the user 505-c, and the user 505-d may each be an example of a user 305 as illustrated by and described with reference to FIGS. 3A and 3B. Additionally, or alternatively, the user 505-a, the user 505-b, the user 505-c, and the user 505-d may be examples of the user 405-a, the user 405-b, the user 405-c, and the user 405-d as illustrated by and described with reference to FIG. 4. Each user may be associated with a corresponding UE 115, such that communication between a network entity 105 and a user may be understood as communication between the network entity 105 and a UE 115 corresponding to the user. The network entity 105-a, the network entity 105-b, the network entity 105-c, and the network entity 105-d may each be an example of a network entity 105 as illustrated by and described with reference to FIGS. 1, 2, 3A, 3B, and 4. The application server 510 (e.g., an SFU) may be an example of the application server 220, the application server 320, or the application server 410 as illustrated by and described with reference to FIGS. 2, 3A, 3B, and 4. The application server 510 may be associated with an SFU architecture that is utilized for holographic communications.

In the following description of the process flow 500, the operations between the UEs 115 (e.g., the users), the network entities 105, and the application server 510 may be communicated in a different order than the example order shown, or the operations performed by one or more of the UEs 115, the network entities 105, and the application server 510 may be performed in different orders or at different times. Some operations may also be omitted from the process flow 500, and other operations may be added to the process flow 500. Further, as described herein, aspects of the functions performed by one or more of the UEs 115 may additionally, or alternatively, be performed by one or more other wireless communication devices (e.g., one or more peripheral devices). Further, operations described herein as being performed by a user may be equivalently understood as being performed by a UE 115 associated with the user.

At 512, the user 505-d may provide the application server 510 with a manifest file (e.g., a message) that includes or indicates a set of transcoding parameters associated with a traffic flow that the user 505-d transmits. The user 505-d may provide the manifest file to the application server 510 to enable the application server 510 to transcode packets of the traffic flow. In some aspects, the user 505-d may transmit the manifest file to the application server 510 via out-of-band signaling. In some aspects, the user 505-d may provide the application server 510 with the manifest file at a beginning of the holographic communications session (e.g., call) or at any time during the holographic communication session, or both.

At 514, the user 505-d may encode a set of packets of the traffic flow. In some aspects, the user 505-d may encode the set of packets with a highest bit rate. At 516, the user 505-d may transmit the (encoded) set of packets, which the network entity 105-d associated with the user 505-d may provide to the application server 510. In some aspects, the application server 510 may refrain from transcoding the set of packets received at 516 in accordance with a default or initial operation, such as in the absence of information indicating that the user 505-a, the user 505-b, or the user 505-c is experiencing congestion. In such aspects, the application server 510 may, at 518, 520, and 522, output a first coded version 524-a (a same coded version) of the set of packets to each of the user 505-c, the user 505-b, and the user 505-a, respectively. The first coded version 524-a of the set of packets may be associated with the same coding rate used by the user 505-d to encode the set of packets (e.g., a highest coding rate or a highest bit rate).

At 522, the network entity 105-a (e.g., the RAN) associated with the user 505-a may detect congestion and may include one or more ECN markings in the coded packets that are received by the user 505-a. At 526, the user 505-a may send ECN feedback (e.g., a feedback message) to the application server 510 (e.g., via out-of-band signaling) to indicate the congestion to the application server 510. In some examples, the ECN feedback may include an ID corresponding to a source of the packets. For example, the ECN feedback may include an ID that corresponds to the user 505-d (to indicate that the user 505-d was a source of the packets received by the user 505-a with ECN makings). In some aspects, when the application server 510 receives an ECN feedback from a receiving client device (e.g., the user 505-a) associated with a traffic flow, and if the application server 510 has received (e.g., has been provided with) a manifest file for transcoding this traffic flow, the application server 510 may utilize the ECN feedback to transcode the incoming packets of this traffic flow to a more appropriate or suitable bit rate for the receiving client device that transmitted the ECN feedback (e.g., the user 505-a).

For example, at 528, the user 505-d may transmit a next set of packets of the traffic flow, which the network entity 105-d associated with the user 505-d may provide to the application server 510. At 530 and 532, the application server 510 may output a first coded version 524-a of the set of packets to the user 505-c and the user 505-b, respectively. In some aspects, the first coded version 524-a may be associated with a same coding rate as the user 505-d used to encode the packets (e.g., in accordance with the user 505-c and the user 505-b not reporting congestion). At 534, the application server 510 may perform a re-encoding operation to re-encode the set of packets received from the user 505-d at 528 into a second coded version 524-b of the set of packets. The application server 510 may re-encode the set of packets to the second coded version 524-b of the set of packets in accordance with receiving the ECN feedback from the user 505-a at 526, and, at 536, may output the second coded version 524-b of the set of packets for the user 505-a. In some aspects, the second coded version 524-b may be associated with a lower coding rate (e.g., a lower data rate, a lower bit rate) than the first coded version 524-a (e.g., in accordance with the user 505-a experiencing congestion).

In some aspects, the application server 510 may report, to each transmitting client device, the bit rates (e.g., the coding rates) that the application server 510 used to transmit the traffic flow to the receiving client devices. For example, the application server 510 may transmit, to the user 505-d, an indication that the application server 510 used a first coding rate (associated with the first coded version 524-a) for packet transmissions to the user 505-c and the user 505-b and that the application server 510 used a second coding rate (associated with the second coded version 524-b) for packet transmissions to the user 505-a. The application server 510 may transmit such a report to each transmitting client device via out-of-band signaling. In some aspects, a transmitting client device (e.g., the user 505-d) may use the reported information to update a highest bit rate (e.g., a highest coding rate) that the transmitting client device is using for transmitting packets of the traffic flow. For example, a transmitting client device may increase the highest bit rate in accordance with the application server 510 transmitting packets with coding rates near or at a current highest bit rate (for a threshold quantity of receiving client devices). By way of further example, a transmitting client device may decrease the highest bit rate in accordance with the application server 510 transmitting packets with coding rates at least a threshold below a current highest bit rate (for a threshold quantity of receiving client devices).

In some aspects, each transmitting client device may configure the application server 510 with a reporting configuration associated with reporting information indicative of which bit rates the application server 510 is using for packet transmissions to the receiving client devices. For example, the user 505-d may transmit information indicative of a reporting configuration to the application server 510 (e.g., via out-of-band signaling) and the application server 510 may report bit rate information to the user 505-d in accordance with the reporting configuration. A reporting configuration may include, define, indicate, or be associated with a reporting condition (e.g., periodic or event-triggered), a reporting period (if periodic), a triggering event (if event-triggered, and such as a highest or lowest bit rate used for transmissions having changed since a previous (most recent) report).

In addition to ECN feedback messages from receiving client devices, the application server 510 may use other information from the receiving client devices to inform the selective re-encoding operation (e.g., the bit rate selection) at the application server 510. In some aspects, for example, each client device (e.g., each of the user 505-a, the user 505-b, the user 505-c, and the user 505-d) may report information related to (e.g., associated with) a current link condition to the application server 510. Such information may include, for example, an indication of one or more suggested bit rates (e.g., that the client device expects or predicts to be most adapted to the current link conditions experienced by the client device), an upper limit (e.g., a maximum) supported bit rate, one or more measurements of a radio quality (e.g., an RSRP metric or a CQI metric, among other examples), an LCE, an RTT, or any combination thereof. In some aspects, the client device may report such information to the application server 510 from a modem of the client device via a cross-layer API.

In some aspects, the application server 510 may configure a client device (such as each client device) with a reporting configuration associated with such information (e.g., such link condition information). The reporting configuration may include, define, indicate, or be associated with a set of reporting objects (e.g., suggested bit rates, RSRP, or CQI, among other examples), a list of available bit rates, a reporting condition (e.g., periodic or event-triggered), a reporting period (if periodic), a triggering event (if event-triggered, and such as the suggested bit rate(s) having changed since a previous (most recent) report, or an RSRP having changed by a threshold amount X (which may be configurable between the application server 510 and one or more client devices, such as each client device)), or any combination thereof. In some aspects, a client device may transmit a report including such information, and/or may receive a reporting configuration associated with reporting such information, via out-of-band signaling between the client device and the application server 510.

In some aspects, one or more of the devices illustrated by the process flow 500 may support one or more signaling mechanisms to provide bit rate awareness at the RAN. For example, the RAN may benefit from receiving information indicative of which bit rates a client device may transmit and/or receive. The RAN may use such information for one or more network operations, such as RRM (e.g., BWP selection) or for CAC. In such aspects, whenever a client device updates a bit rate that the client device uses for transmitting packets of a traffic flow, the client device may report this bit rate to the RAN (e.g., via a transmission to a network entity 105). The client device may transmit the report via RRC signaling (e.g., via UAI), a MAC-CE, or via Layer 1 signaling (e.g., UCI). The report may include a flow ID (e.g., a QoS flow ID, a DRB ID) and some additional information, such as a bit rate.

In some aspects, the application server 510 may provide (e.g., output or transmit to) each client device with a list of available bit rates for each traffic flow that this client device receives. The application server 510 may provide or otherwise indicate the list of available encoding layers for each traffic flow via out-of-band signaling. For example, in accordance with receiving the indication of the manifest file associated with the encoding at the user 505-d, the application server 510 may forward the indication of the available bit rates (e.g., bit rates {X, Y, Z}) to each of the user 505-c, the user 505-b, and the user 505-a via out-of-band signaling. A client device that receives the information indicative of the bit rates that are available for a downlink traffic flow may report this information to the RAN. For example, in accordance with receiving the indication of the available layers, each of the user 505-c, the user 505-b, and the user 505-a may transmit (e.g., relay or forward) an indication of the available bit rates to an associated network entity 105. By way of further example, the user 505-c may transmit the indication of the available bit rates to the network entity 105-c, the user 505-b may transmit the indication of the available bit rates to the network entity 105-b, and the user 505-a may transmit the indication of the available bit rates to the network entity 105-a. The report may be an RRC message (e.g., UAI), a MAC-CE, or L1 signaling (e.g., UCI). The report may include or indicate a list of traffic flows and, for each traffic flow in the list of traffic flows, a flow ID (e.g., a QoS flow ID or a DRB ID) and a list of available bit rates. In this way, a client device may indicate, to a serving network entity 105, the possible bit rates that the client device may receive packets in accordance with.

In accordance with such aspects, the application server 510 may facilitate selective coding for various sets of packets over time on a per destination basis, along with enabling further coordination between devices to provide greater synchronization and more accurate or suitable resource allocation, among other benefits.

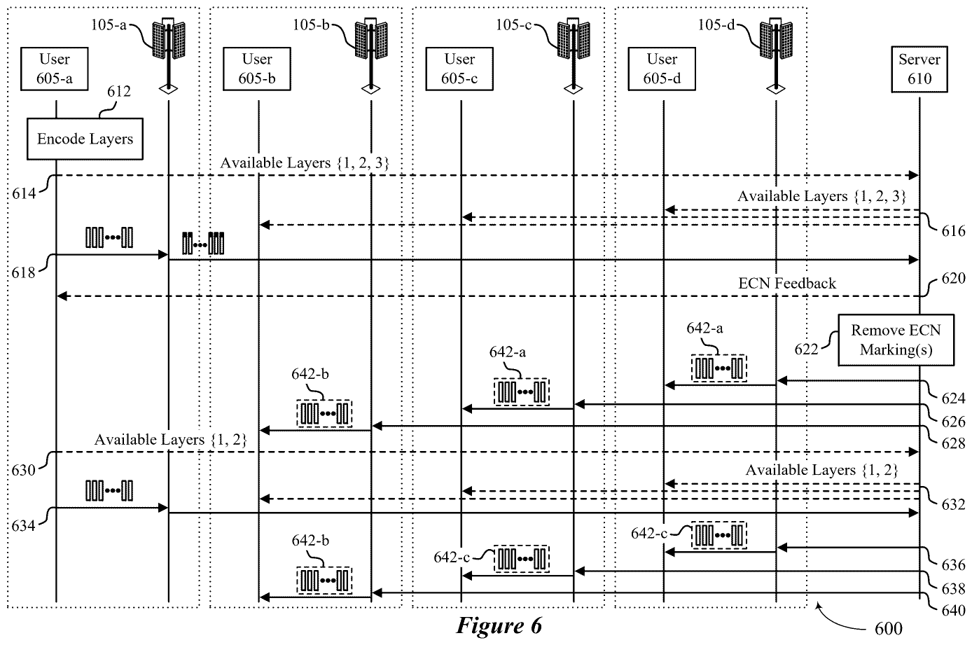

FIG. 6 shows an example of a process flow 600 associated with ECN marking removal that supports coding rate control for holographic communications. In some examples, the process flow 600 may implement or be implemented by aspects of the wireless communication system 100, the wireless communication system 200, the process flow 300-a, the process flow 300-b, the process flow 400, the process flow 500, or any combination thereof. For example, the process flow 600 illustrates signaling involving a user 605-a, a network entity 105-a, a user 605-b, a network entity 105-b, a user 605-c, a network entity 105-c, a user 605-d, a network entity 105-d, and an application server 610.

The user 605-a, the user 605-b, the user 605-c, and the user 605-d may each be an example of a user 305 as illustrated by and described with reference to FIGS. 3A and 3B. Additionally, or alternatively, the user 605-a, the user 605-b, the user 605-μc, and the user 605-d may be examples of the user 405-a, the user 405-b, the user 405-c, and the user 405-d as illustrated by and described with reference to FIG. 4, and/or of the user 505-a, the user 505-b, the user 505-c, and the user 505-d as illustrated by and described with reference to FIG. 5. Each user may be associated with a corresponding UE 115, such that communication between a network entity 105 and a user may be understood as communication between the network entity 105 and a UE 115 corresponding to the user. The network entity 105-a, the network entity 105-b, the network entity 105-c, and the network entity 105-d may each be an example of a network entity 105 as illustrated by and described with reference to FIGS. 1, 2, 3A, 3B, 4, and 5. The application server 610 (e.g., an SFU) may be an example of the application server 220, the application server 320, the application server 410, and/or the application server 510 as illustrated by and described with reference to FIGS. 2, 3A, 3B, 4, and 5. The application server 610 may be associated with an SFU architecture that is utilized for holographic communications.

In the following description of the process flow 600, the operations between the UEs 115 (e.g., the users), the network entities 105, and the application server 610 may be communicated in a different order than the example order shown, or the operations performed by one or more of the UEs 115, the network entities 105, and the application server 610 may be performed in different orders or at different times. Some operations may also be omitted from the process flow 600, and other operations may be added to the process flow 600. Further, as described herein, aspects of the functions performed by one or more of the UEs 115 may additionally, or alternatively, be performed by one or more other wireless communication devices (e.g., one or more peripheral devices). Further, operations described herein as being performed by a user may be equivalently understood as being performed by a UE 115 associated with the user.

At 612, the user 605-a may encode a set of packets with multiple layers. For example, the user 605-a may encode a set of packets associated with a traffic flow with three layers including a first encoding layer (e.g., associated with a lowest coding rate), a second encoding layer (e.g., associated with an intermediate coding rate), and a third encoding layer (e.g., associated with a highest coding rate). At 614, the user 605-a may transmit (via out-of-band signaling) an indication of the set of available encoding layers associated with the packets from the user 605-a to the application server 610. For example, the user 605-a may indicate that the user 605-a will provide different coded versions of packets according to the first encoding layer, the second encoding layer, and the third encoding layer. Additionally, or alternatively, the user 605-a may provide the application server 610 with a set of transcoding parameters associated with re-encoding packets transmitted by the user 605-a.

At 616, the application server 610 may output (via out-of-band signaling) an indication of the available encoding layers (and/or a set of available coding rates or bit rates) to each of the user 605-b, the user 605-c, and the user 605-d. At 618, the user 605-a may transmit a set of packets associated with the traffic flow, which the network entity 105-a associated with the user 605-a may provide to the application server 610. In some scenarios, the network entity 105-a may detect congestion and may include an ECN marking in the set of packets that the network entity 105-a provides to the application server 610. At 620, in accordance with obtaining the packets with the ECN markings at 618, the application server 610 may output ECN feedback (e.g., a feedback message) to the user 605-a (e.g., via out-of-band signaling).

At 622, the application server 610 may remove ECN markings from the set of packets received at 618. In some aspects, for example, if the application server 610 detects ECN marking on a traffic flow (e.g., in packets associated with the traffic flow), the application server 610 may determine that there may be congestion between the transmitting client device (e.g., the user 605-a) and the application server 610. In examples in which the traffic flow is associated with or using layered encoding and/or transcoding, the application server 610 may remove the ECN marking from the set of packets (e.g., IP packets) prior to forwarding the packets to receiving client devices. In such aspects, the application server 610 may avoid sending packets with ECN markings to receiving client devices, which may in turn avoid the receiving client devices sending ECN feedback to the application server 610. If the receiving client devices had received packets with ECN markings and transmitted ECN feedback to the application server 610, the application server 610 may have (mistakenly, incorrectly, or inaccurately) determined that there is congestion between the application server 610 and the receiving client devices.

Accordingly, if the application server 610 detects an ECN marking on a traffic flow that is using layered encoding or transcoding, the application server 610 may transmit an ECN feedback message to the transmitting client device of that traffic flow. Additionally, or alternatively, if the application server 610 detects an ECN marking on a traffic flow that is using layered encoding or transcoding, the application server 610 may remove the ECN marking from the IP packets before forwarding the IP packets to a set of receiving client devices.

In accordance with removing the ECN markings from the set of packets received from the user 605-a, the application server 610 may, at 624, 626, and 628, output a respective coded version of the set of packets to the user 605-d, the user 605-μc, and the user 605-b, respectively. In some aspects, the application server 610 may output a first coded version 642-a of the set of packets to the user 605-d and the user 605-c and may output a second coded version 642-b of the set of packets to the user 605-b. The first coded version 642-a may be associated with a first encoding layer and the second coded version 642-b may be associated with a second encoding layer. Additionally, or alternatively, the first coded version 642-a may be associated with an absence of re-encoding by the application server 610 and the second coded version 642-b may be associated with a re-encoding by the application server 610 (e.g., in accordance with a set of transcoding parameters).

At 630, the user 605-a may update a set of encoding layers that are available for packets associated with the traffic flow. Additionally, or alternatively, the user 605-a may update a set of coding rates (e.g., bit rates) that are available for packets associated with the traffic flow. The user 605-a may transmit an indication of the set of available encoding layers (and/or the set of available coding rates) to the application server 610 (e.g., via out-of-band signaling). At 632, the application server 610 may output (via out-of-band signaling) an indication of the available encoding layers (and/or a set of available coding rates or bit rates) to each of the user 605-b, the user 605-c, and the user 605-d. At 634, the user 605-a may transmit a next set of packets associated with the traffic flow, which the network entity 105-a associated with the user 605-a may provide to the application server 610.

The application server 610 may, at 636, 638, and 640, output a respective coded version of the set of packets to the user 605-d, the user 605-c, and the user 605-b, respectively. In some aspects, the application server 610 may output a third coded version 642-c of the set of packets to the user 605-d and the user 605-c and may output the second coded version 642-b of the set of packets to the user 605-b. The third coded version 642-c may be associated with a third encoding layer and the second coded version 642-b may be associated with the second encoding layer. Additionally, or alternatively, the third coded version 642-c may be associated with an absence of re-encoding by the application server 610 and the second coded version 642-b may be associated with a re-encoding by the application server 610 (e.g., in accordance with a set of transcoding parameters).

In accordance with one or more of such aspects, the described techniques may support congestion management for multi-user calls (including holographic communications) using the SFU architecture when layered encoding and/or transcoding is applied. For example, the SFU (e.g., an application server) may select an encoding layer and/or transcode packets according to ECN feedback and the SFU may report to the transmitting client devices information that the transmitting client devices may use to update, refine, or otherwise assist their traffic flows. Further, receiving client devices may report to the SFU information that the SFU may use to update, refine, or otherwise assist in an encoding layer and/or bit rate selection. Additionally, in some aspects, client devices may report information to the RAN, which may enable the RAN to update, refine, or otherwise improve one or more RRM operations, among other network operations.

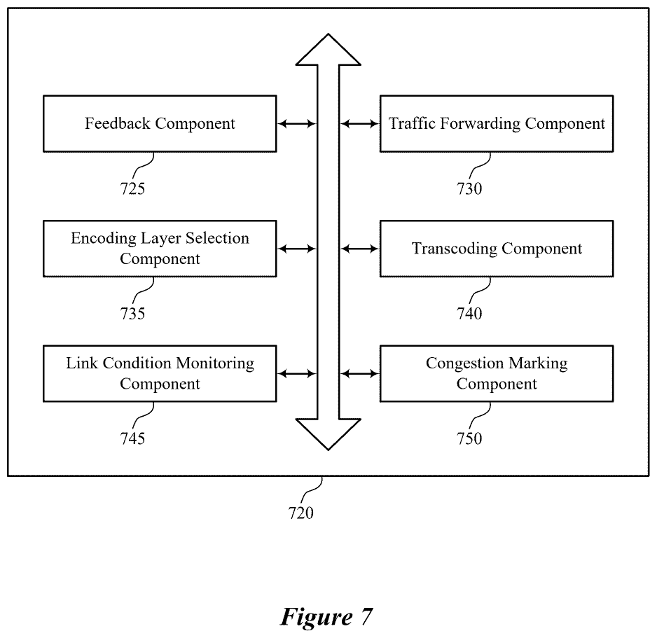

FIG. 7 shows an example of a processing system 720 that supports coding rate control for holographic communications. A processing system 720 may be an example of a processing system 145 (such as of a network entity 105). An application server may include a processing system 720. A processing system 720 may include a feedback component 725, a traffic forwarding component 730, an encoding layer selection component 735, a transcoding component 740, a link condition monitoring component 745, a congestion marking component 750, or any combination thereof. A processing system 720, or various component thereof, may be an example of means for performing (such as a means for causing an application server to perform) various techniques described herein.

The feedback component 725 may be configured to cause the application server to obtain a feedback message that includes congestion information pertaining to a traffic flow associated with holographic communications between a set of multiple wireless communication devices, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow. The traffic forwarding component 730 may be configured to cause the application server to obtain a first set of packets of the traffic flow associated with the holographic communications, where the first set of packets is associated with a set of multiple encoding layers that correspond to a layered encoding scheme at the second wireless communication device. The encoding layer selection component 735 may be configured to cause the application server to output a second set of packets that corresponds to the first set of packets in accordance with a selection, at the application server, of a respective encoding layer of the set of multiple encoding layers on a per-destination basis, where the selection is based on the congestion information.

In some examples, to support outputting the second set of packets, the encoding layer selection component 735 may be configured to cause the application server to output a first coded version of the second set of packets according to a first encoding layer of the set of multiple encoding layers based on the congestion information, where a first destination of the first coded version of the second set of packets is the first wireless communication device. In some examples, to support outputting the second set of packets, the encoding layer selection component 735 may be configured to cause the application server to output a second coded version of the second set of packets according to a second encoding layer of the set of multiple encoding layers different than the first encoding layer, where a second destination of the second coded version of the second set of packets is a third wireless communication device of the set of multiple wireless communication devices.

In some examples, to support obtaining the first set of packets, the traffic forwarding component 730 may be configured to cause the application server to obtain the first coded version of the first set of packets according to the first encoding layer. In some examples, to support obtaining the first set of packets, the traffic forwarding component 730 may be configured to cause the application server to obtain the second coded version of the first set of packets according to the second encoding layer, where the selection includes selecting the first coded version of the first set of packets to be output to the first wireless communication device and selecting the second coded version of the first set of packets to be output to the third wireless communication device.

In some examples, the first encoding layer is associated with a lower coding rate than the second encoding layer.

In some examples, packets of the traffic flow addressed to the third wireless communication device are absent of any explicit congestion notification marking. In some examples, the first encoding layer is associated with the lower coding rate than the second encoding layer in accordance with the packets of the traffic flow addressed to the third wireless communication device being absent of any explicit congestion notification marking.

In some examples, the traffic forwarding component 730 may be configured to cause the application server to obtain a third set of packets of the traffic flow. In some examples, the traffic forwarding component 730 may be configured to cause the application server to output a fourth set of packets that corresponds to the third set of packets to each wireless communication device of the set of multiple wireless communication devices other than the second wireless communication device, where the one or more packets with the explicit congestion notification marking are at least a subset of the fourth set of packets that are output to the first wireless communication device, and where obtaining the feedback message is in accordance with outputting the fourth set of packets.

In some examples, the encoding layer selection component 735 may be configured to cause the application server to obtain information associated with the layered encoding scheme at the second wireless communication device, where the selection is further based on the information associated with the layered encoding scheme.

In some examples, the information associated with the layered encoding scheme indicates whether the second wireless communication device utilizes the layered encoding scheme.

In some examples, the information associated with the layered encoding scheme indicates the set of multiple encoding layers and one or more respective encoding parameters associated with each encoding layer of the set of multiple encoding layers.

In some examples, the encoding layer selection component 735 may be configured to cause the application server to output a report that indicates the selection, at the application server, of the respective encoding layer of the set of multiple encoding layers on the per-destination basis.

In some examples, the encoding layer selection component 735 may be configured to cause the application server to obtain updated information associated with the layered encoding scheme at the second wireless communication device in accordance with outputting the report that indicates the selection, where the updated information indicates at least one of whether the second wireless communication device utilizes the layered encoding scheme or an updated set of multiple encoding layers and one or more respective encoding parameters associated with each encoding layer of the updated set of multiple encoding layers.

In some examples, the encoding layer selection component 735 may be configured to cause the application server to obtain configuration information that indicates a reporting configuration associated with the selection, where outputting the report that indicates the selection is in accordance with the reporting configuration.

In some examples, the reporting configuration is associated with at least one of a reporting condition, a reporting period, or a triggering event.

In some examples, outputting the report that indicates the selection or obtaining the configuration information that indicates the reporting configuration is via a first channel that is different than a second channel associated with the holographic communications.

In some examples, the link condition monitoring component 745 may be configured to cause the application server to obtain link condition information associated with a wireless communication link between the first wireless communication device and a network entity, where the selection is further based on the link condition information.

In some examples, to support obtaining the link condition information, the link condition monitoring component 745 may be configured to cause the application server to obtain the link condition information via a cross-layer application programming interface associated with a modem of the first wireless communication device.

In some examples, the link condition monitoring component 745 may be configured to cause the application server to output configuration information that indicates a reporting configuration associated with the link condition information, where obtaining the link condition information is in accordance with the reporting configuration.

In some examples, the reporting configuration is associated with at least one of a set of reporting objects, a list of available encoding layers, a reporting condition, a reporting period, or a triggering event.

In some examples, obtaining the link condition information or outputting the configuration information that indicates the reporting configuration is via a first channel that is different than a second channel associated with the holographic communications.

In some examples, the encoding layer selection component 735 may be configured to cause the application server to output information that indicates the set of multiple encoding layers associated with the layered encoding scheme at the second wireless communication device.

In some examples, the congestion marking component 750 may be configured to cause the application server to detect that a set of packets associated with the traffic flow from the second wireless communication device is associated with one or more explicit congestion notification markings. In some examples, the feedback component 725 may be configured to cause the application server to output a second feedback message that includes second congestion information pertaining to the traffic flow, where the second congestion information is based on the one or more explicit congestion notification markings of the set of packets from the second wireless communication device.

In some examples, the traffic forwarding component 730 may be configured to cause the application server to remove the one or more explicit congestion notification markings from the set of packets from the second wireless communication device prior to outputting the set of packets to each wireless communication device of the set of multiple wireless communication devices other than the second wireless communication device.

In some examples, the second set of packets is a forwarded version of the first set of packets from the second wireless communication device to each wireless communication device of the set of multiple wireless communication devices other than the second wireless communication device.

Additionally, or alternatively, the transcoding component 740 may be configured to cause the application server to obtain a message that includes a set of transcoding parameters corresponding to a traffic flow associated with holographic communications between a set of multiple wireless communication devices. In some examples, the feedback component 725 may be configured to cause the application server to obtain a feedback message that includes congestion information pertaining to the traffic flow, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow. In some examples, the traffic forwarding component 730 may be configured to cause the application server to obtain a first set of packets of the traffic flow that is encoded according to a first coding rate. In some examples, the transcoding component 740 may be configured to cause the application server to output a second set of packets that corresponds to the first set of packets in accordance with a selective re-encoding operation, at the application server, of the first set of packets on a per-destination basis, where the selective re-encoding operation is based on the set of transcoding parameters corresponding to the traffic flow and the congestion information.

In some examples, to support outputting the second set of packets, the traffic forwarding component 730 may be configured to cause the application server to output a first coded version of the second set of packets that is encoded according to the first coding rate, where a first destination of the first coded version of the second set of packets is a third wireless communication device of the set of multiple wireless communication devices. In some examples, to support outputting the second set of packets, the transcoding component 740 may be configured to cause the application server to output a second coded version of the second set of packets that is encoded according to a second coding rate different than the first coding rate based on the set of transcoding parameters and the congestion information, where a second destination of the second coded version of the second set of packets is the first wireless communication device.

In some examples, the second coding rate is lower than the first coding rate.

In some examples, packets of the traffic flow addressed to the third wireless communication device are absent of any explicit congestion notification marking. In some examples, the second coding rate is lower than the first coding rate in accordance with the packets of the traffic flow addressed to the third wireless communication device being absent of any explicit congestion notification marking.

In some examples, the traffic forwarding component 730 may be configured to cause the application server to obtain a third set of packets of the traffic flow. In some examples, the traffic forwarding component 730 may be configured to cause the application server to output a fourth set of packets that corresponds to the third set of packets to each wireless communication device of the set of multiple wireless communication devices other than the second wireless communication device, where the one or more packets with the explicit congestion notification marking are at least a subset of the fourth set of packets, and where obtaining the feedback message is in accordance with outputting the fourth set of packets.

In some examples, to support obtaining the message that includes the set of transcoding parameters, the transcoding component 740 may be configured to cause the application server to obtain the message via a first channel that is different than a second channel associated with the holographic communications.

In some examples, to support obtaining the message that includes the set of transcoding parameters, the transcoding component 740 may be configured to cause the application server to obtain the message at a beginning of a call associated with the holographic communications or at any time during the call associated with the holographic communications.

In some examples, the transcoding component 740 may be configured to cause the application server to output a report that indicates a result of the selective re-encoding operation, at the application server, of the first set of packets on the per-destination basis.

In some examples, the transcoding component 740 may be configured to cause the application server to obtain configuration information that indicates a reporting configuration associated with the result of the selective re-encoding operation, where outputting the report that indicates the result of the selective re-encoding operation is in accordance with the reporting configuration.

In some examples, the reporting configuration is associated with at least one of a reporting condition, a reporting period, or a triggering event.

In some examples, outputting the report that indicates the result of the selective re-encoding operation or obtaining the configuration information that indicates the reporting configuration is via a first channel that is different than a second channel associated with the holographic communications.

In some examples, the link condition monitoring component 745 may be configured to cause the application server to obtain link condition information associated with a wireless communication link between the first wireless communication device and a network entity, where the selective re-encoding operation is further based on the link condition information.

In some examples, to support obtaining the link condition information, the link condition monitoring component 745 may be configured to cause the application server to obtain the link condition information via a cross-layer application programming interface associated with a modem of the first wireless communication device.

In some examples, the link condition monitoring component 745 may be configured to cause the application server to output configuration information that indicates a reporting configuration associated with the link condition information, where obtaining the link condition information is in accordance with the reporting configuration.

In some examples, the reporting configuration is associated with at least one of a set of reporting objects, a list of available bit rates, a reporting condition, a reporting period, or a triggering event.

In some examples, obtaining the link condition information or outputting the configuration information that indicates the reporting configuration is via a first channel that is different than a second channel associated with the holographic communications.

In some examples, the transcoding component 740 may be configured to cause the application server to output information that indicates the set of transcoding parameters corresponding to the traffic flow.

In some examples, the congestion marking component 750 may be configured to cause the application server to detect that a set of packets associated with the traffic flow from the second wireless communication device are associated with one or more explicit congestion notification markings. In some examples, the feedback component 725 may be configured to cause the application server to output a second feedback message that includes second congestion information pertaining to the traffic flow, where the second congestion information is based on the one or more explicit congestion notification markings of the set of packets from the second wireless communication device.

In some examples, the congestion marking component 750 may be configured to cause the application server to remove the one or more explicit congestion notification markings from the set of packets from the second wireless communication device prior to outputting the set of packets to each wireless communication device of the set of multiple wireless communication devices other than the second wireless communication device.

In some examples, the second set of packets is a forwarded version of the first set of packets from the second wireless communication device to each wireless communication device of the set of multiple wireless communication devices other than the second wireless communication device.

A processing system 720 may include or be an example of one or more chips, SoCs, chipsets, packages, components, or devices that individually or collectively constitute or include a processing system. A processing system 720 may interface with one or more components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105 or of an application server). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105 or an application server, between devices, components, or virtualized components associated with a network entity 105 or an application server), or any combination thereof.

By including or configuring a processing system 720 for operation in a processing system 720 as described herein, the processing system 720 may support techniques for more efficient utilization of communication resources, among other benefits.

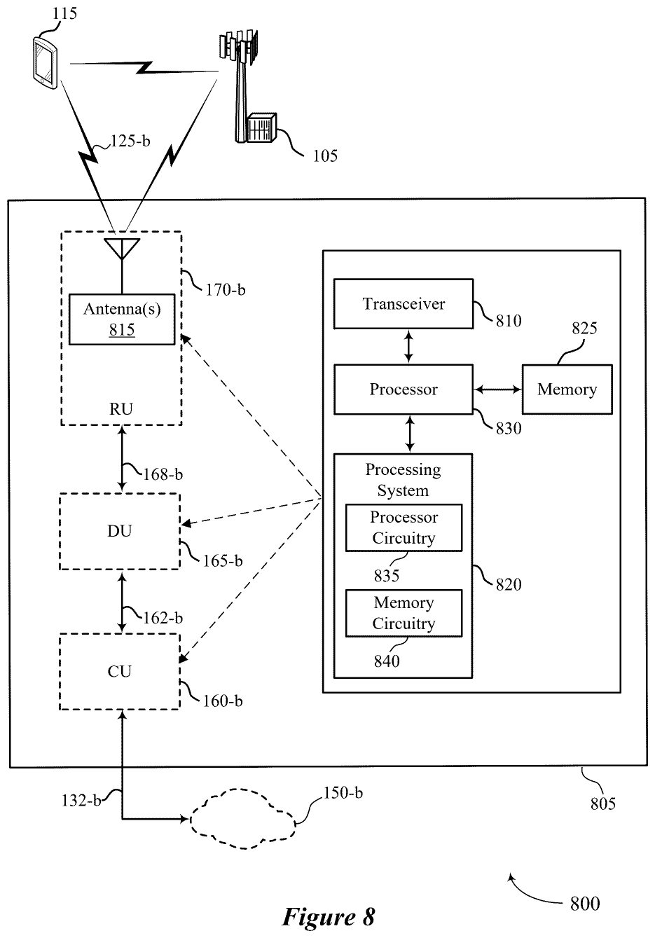

FIG. 8 shows an example of a system 800 including a device 805 that supports coding rate control for holographic communications. The device 805 may be an example of a device associated with an application server, such as an application server itself, a device within an application server, or a device that performs operations for an application server. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 720. For example, the processing system 820 may include processor circuitry 835 and memory circuitry 840 that stores code, and the processing system 820 may be configured to cause the device 805 to perform operations that support coding rate control for holographic communications. Although the processing system 820 is illustrated as a separate component, which may involve a separate chip, chipset, or other module, in some aspects, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for improved communication reliability, reduced latency, improved user experience related to greater reliability (such as resulting from more suitable coding rates on a per destination basis), more efficient utilization of communication resources, improved coordination between devices, and improved utilization of processing capability.

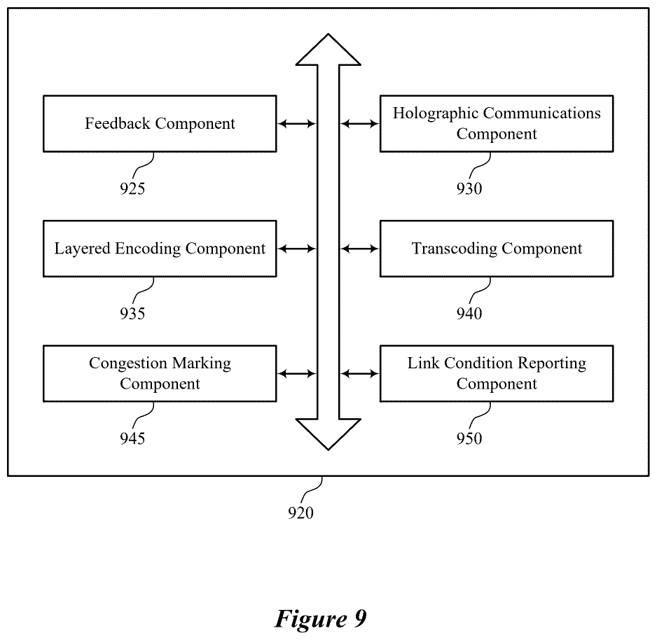

FIG. 9 shows an example of a processing system 920 that supports coding rate control for holographic communications. A processing system 920 may be an example of a processing system 140 (such as of a UE 115) and may include a feedback component 925, a holographic communications component 930, a layered encoding component 935, a transcoding component 940, a congestion marking component 945, a link condition reporting component 950, or any combination thereof. A processing system 920, or various component thereof, may be an example of means for performing (such as a means for causing a UE 115, or any first wireless communication device, to perform) various techniques described herein.

The feedback component 925 may be configured to cause the first wireless communication device to transmit a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow. The holographic communications component 930 may be configured to cause the first wireless communication device to receive a set of packets of the traffic flow associated with the holographic communications according to an encoding layer, of a set of multiple encoding layers that correspond to a layered encoding scheme at the second wireless communication device, based on the congestion information.

In some examples, the congestion marking component 945 may be configured to cause the first wireless communication device to receive a second set of packets of the traffic flow associated with the holographic communications, where the one or more packets with the explicit congestion notification marking are at least a subset of the second set of packets, and where transmitting the feedback message is in accordance with receiving the second set of packets.

In some examples, the link condition reporting component 950 may be configured to cause the first wireless communication device to transmit link condition information associated with a wireless communication link between the first wireless communication device and a network entity, where receiving the set of packets of the traffic flow according to the encoding layer, of the set of multiple encoding layers that correspond to the layered encoding scheme at the second wireless communication device, is further based on the link condition information.

In some examples, to support transmitting the link condition information, the link condition reporting component 950 may be configured to cause the first wireless communication device to transmit the link condition information via a cross-layer application programming interface associated with a modem of the first wireless communication device.

In some examples, the link condition reporting component 950 may be configured to cause the first wireless communication device to receive information that indicates a reporting configuration associated with the link condition information, where transmitting the link condition information is in accordance with the reporting configuration.

In some examples, the reporting configuration is associated with at least one of a set of reporting objects, a list of available encoding layers, a reporting condition, a reporting period, or a triggering event.

In some examples, transmitting the link condition information or receiving the information that indicates the reporting configuration is via a first channel that is different than a second channel associated with the holographic communications.

In some examples, the layered encoding component 935 may be configured to cause the first wireless communication device to receive information that indicates the set of multiple encoding layers associated with the layered encoding scheme at the second wireless communication device.

In some examples, the layered encoding component 935 may be configured to cause the first wireless communication device to transmit an uplink message that indicates the set of multiple encoding layers associated with the layered encoding scheme at the second wireless communication device, where a radio access network associated with the first wireless communication device is based on the set of multiple encoding layers associated with the layered encoding scheme at the second wireless communication device.

Additionally, or alternatively, the layered encoding component 935 may be configured to cause the first wireless communication device to transmit information associated with a layered encoding scheme at the first wireless communication device in association with holographic communications between a set of multiple wireless communication devices including the first wireless communication device. In some examples, the holographic communications component 930 may be configured to cause the first wireless communication device to transmit a set of packets of a traffic flow that is associated with the holographic communications, where the set of packets is associated with a set of multiple encoding layers that correspond to the layered encoding scheme at the first wireless communication device. In some examples, the layered encoding component 935 may be configured to cause the first wireless communication device to receive a report that indicates a selection, at an application server associated with the holographic communications, of a respective encoding layer of the set of multiple encoding layers on a per-destination basis.

In some examples, the selection is based on congestion information associated with a second wireless communication device of the set of multiple wireless communication devices. In some examples, the congestion information is based on an explicit congestion notification marking of one or more packets of the traffic flow addressed to the second wireless communication device.

In some examples, to support transmitting the set of packets, the layered encoding component 935 may be configured to cause the first wireless communication device to transmit a first coded version of the set of packets according to a first encoding layer of the set of multiple encoding layers. In some examples, to support transmitting the set of packets, the layered encoding component 935 may be configured to cause the first wireless communication device to transmit a second coded version of the set of packets according to a second encoding layer of the set of multiple encoding layers.

In some examples, the first encoding layer is associated with a different coding rate than the second encoding layer.

In some examples, the information associated with the layered encoding scheme indicates whether the first wireless communication device utilizes the layered encoding scheme.

In some examples, the information associated with the layered encoding scheme indicates the set of multiple encoding layers and one or more respective encoding parameters associated with each encoding layer of the set of multiple encoding layers.

In some examples, the layered encoding component 935 may be configured to cause the first wireless communication device to transmit updated information associated with the layered encoding scheme at the first wireless communication device in accordance with receiving the report that indicates the selection, where the updated information indicates at least one of whether the first wireless communication device utilizes the layered encoding scheme or an updated set of multiple encoding layers and one or more respective encoding parameters associated with each encoding layer of the updated set of multiple encoding layers.

In some examples, the layered encoding component 935 may be configured to cause the first wireless communication device to transmit configuration information that indicates a reporting configuration associated with the selection, where receiving the report that indicates the selection is in accordance with the reporting configuration.

In some examples, the reporting configuration is associated with at least one of a reporting condition, a reporting period, or a triggering event.

In some examples, receiving the report that indicates the selection or transmitting the configuration information that indicates the reporting configuration is via a first channel that is different than a second channel associated with the holographic communications.

In some examples, the layered encoding component 935 may be configured to cause the first wireless communication device to transmit an uplink message that indicates the set of multiple encoding layers associated with the layered encoding scheme at the first wireless communication device, where a radio access network associated with the first wireless communication device is based on the set of multiple encoding layers associated with the layered encoding scheme at the first wireless communication device.

In some examples, the feedback component 925 may be configured to cause the first wireless communication device to transmit a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow. In some examples, the holographic communications component 930 may be configured to cause the first wireless communication device to receive a set of packets of the traffic flow according to a coding rate, of a set of multiple coding rates that correspond to a selective re-encoding operation associated with the holographic communications, based on the congestion information.

In some examples, the congestion marking component 945 may be configured to cause the first wireless communication device to receive a second set of packets of the traffic flow, where the one or more packets with the explicit congestion notification marking are at least a subset of the second set of packets, and where transmitting the feedback message is in accordance with receiving the second set of packets.

In some examples, the link condition reporting component 950 may be configured to cause the first wireless communication device to transmit link condition information associated with a wireless communication link between the first wireless communication device and a network entity, where the selective re-encoding operation is further based on the link condition information.

In some examples, to support transmitting the link condition information, the link condition reporting component 950 may be configured to cause the first wireless communication device to transmit the link condition information via a cross-layer application programming interface associated with a modem of the first wireless communication device.

In some examples, the link condition reporting component 950 may be configured to cause the first wireless communication device to receive configuration information that indicates a reporting configuration associated with the link condition information, where transmitting the link condition information is in accordance with the reporting configuration.

In some examples, the reporting configuration is associated with at least one of a set of reporting objects, a list of available bit rates, a reporting condition, a reporting period, or a triggering event.

In some examples, transmitting the link condition information or receiving the configuration information that indicates the reporting configuration is via a first channel that is different than a second channel associated with the holographic communications.

In some examples, the transcoding component 940 may be configured to cause the first wireless communication device to receive information that indicates a set of transcoding parameters corresponding to the traffic flow, where the selective re-encoding operation is in accordance with the set of transcoding parameters.

In some examples, the transcoding component 940 may be configured to cause the first wireless communication device to transmit an uplink message that indicates the set of transcoding parameters, where a radio access network associated with the first wireless communication device is based on the set of transcoding parameters.

Additionally, or alternatively, the transcoding component 940 may be configured to cause the first wireless communication device to transmit, in association with holographic communications between a set of multiple wireless communication devices including the first wireless communication device, a message that includes a set of transcoding parameters corresponding to a traffic flow associated with the holographic communications. In some examples, the holographic communications component 930 may be configured to cause the first wireless communication device to transmit a set of packets of the traffic flow that is encoded according to a first coding rate. In some examples, the transcoding component 940 may be configured to cause the first wireless communication device to receive a report that indicates a result of a selective re-encoding operation, at an application server associated with the holographic communications, of the set of packets on a per-destination basis.

In some examples, the transcoding component 940 may be configured to cause the first wireless communication device to update a coding rate associated with the traffic flow from the first coding rate to a second coding rate based on the result of the selective re-encoding operation.

In some examples, to support transmitting the message that includes the set of transcoding parameters, the transcoding component 940 may be configured to cause the first wireless communication device to transmit the message via a first channel that is different than a second channel associated with the holographic communications.

In some examples, to support transmitting the message that includes the set of transcoding parameters, the transcoding component 940 may be configured to cause the first wireless communication device to transmit the message at a beginning of a call associated with the holographic communications or at any time during the call associated with the holographic communications.

In some examples, the transcoding component 940 may be configured to cause the first wireless communication device to transmit configuration information that indicates a reporting configuration associated with the result of the selective re-encoding operation, where receiving the report that indicates the result of the selective re-encoding operation is in accordance with the reporting configuration.

In some examples, the reporting configuration is associated with at least one of a reporting condition, a reporting period, or a triggering event.

In some examples, receiving the report that indicates the result of the selective re-encoding operation or transmitting the configuration information that indicates the reporting configuration is via a first channel that is different than a second channel associated with the holographic communications.

In some examples, the transcoding component 940 may be configured to cause the first wireless communication device to transmit an uplink message that indicates a coding rate associated with the traffic flow, where a radio access network associated with the first wireless communication device is based on the coding rate.

A processing system 920 may include or be a component of one or more chips, systems-on-chips (SoCs), chipsets, packages, components, or devices that individually or collectively constitute or include a processing system. A processing system 920 may interface with other components of a processing system 920. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a processing system 920).

By including or configuring a processing system 920 for operation in a processing system 920 as described herein, the processing system 920 may support techniques for more efficient utilization of communication resources, among other benefits.

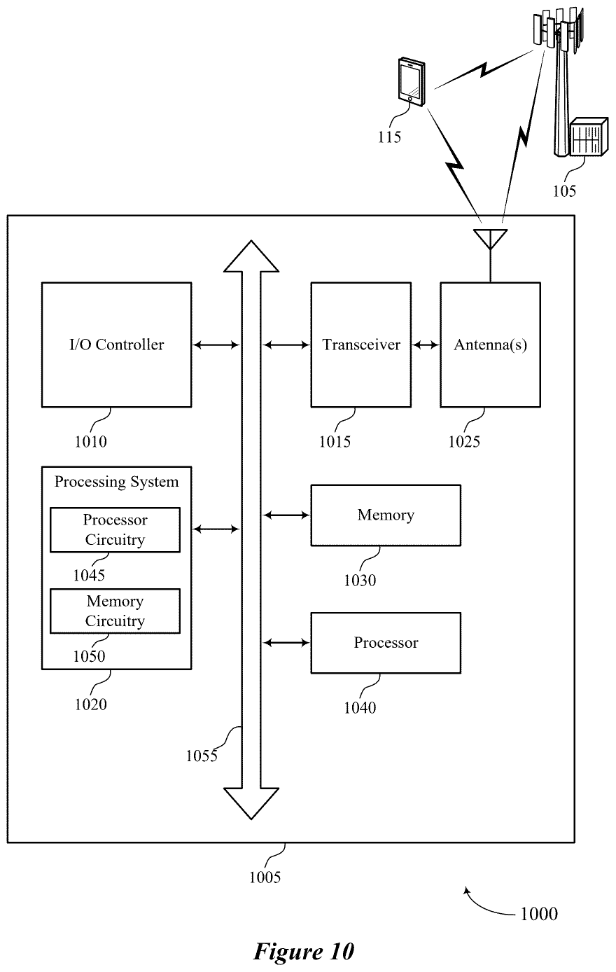

FIG. 10 shows an example of a system 1000 including a device 1005 that supports coding rate control for holographic communications. The device 1005 may be an example of or include components of UE 115. The device 1005 may communicate (such as wirelessly) with one or more other devices (such as network entities 105, UEs 115). The device 1005 may include components for transmitting and receiving communication, which may include a processing system 1020, an input/output (I/O) controller, such as an I/O controller 1010, a transceiver 1015, antenna(s) 1025, a memory 1030, and a processor 1040. Components of the device 1005 may be coupled (such as operatively, communicatively, functionally, electronically, electrically, in electronic communication) a bus 1055.

The transceiver 1015 may support bi-directional communication via antenna(s) 1025, and may support transmission operations, reception operations, or both, as described herein. The transceiver 1015 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1005). The transceiver 1015 may modulate symbols and provide the modulated symbols to antenna(s) 1025 for transmission, and demodulate symbols from signals received using antenna(s) 1025.

The processor 1040 may be a general-purpose processing component that supports various operations (such as applications) of the device 1005. The memory 1030 may be a general-purpose storage component that stores code executable by the processor 1040. Such code may include instructions that, when executed by the processor 1040, cause the device 1005 to perform various functions (such as to support an application of the device 1005). The I/O controller 1010 may manage inputs and outputs for the device 1005, may manage peripherals not integrated into the device 1005, or may represent a physical connection (such as port) to an external peripheral. The processor 1040 may interact with a modem, a keyboard, a mouse, a touchscreen, or other device (such as via I/O controller 1010). In some aspects, a user may interact with the device 1005 via the I/O controller 1010 or via hardware components controlled by the I/O controller 1010.

The processing system 1020 may be an example of a processing system 140 or a processing system 920. For example, the processing system 1020 may include processor circuitry 1045 and memory circuitry 1050 that stores code, and may be configured to cause the device 1005 to perform operations that support coding rate control for holographic communications. Although the processing system 1020 is illustrated as a separate component, which may involve a separate chip, chipset, or other module, in some aspects, one or more functions described with reference to the processing system 1020 may be supported by or performed by a transceiver 1015, antenna(s) 1025, a processor 1040, memory 1030, or any combination thereof, such that a processing system 1020 may include one or more of a transceiver 1015, antenna(s) 1025, a processor 1040, memory 1030, or any combination thereof.

By including or configuring the processing system 1020 for operation in the device 1005 as described herein, may support techniques for improved communication reliability, reduced latency, improved user experience related to greater reliability (such as resulting from more suitable data rates on a per destination basis), more efficient utilization of communication resources, improved coordination between devices, and improved utilization of processing capability.

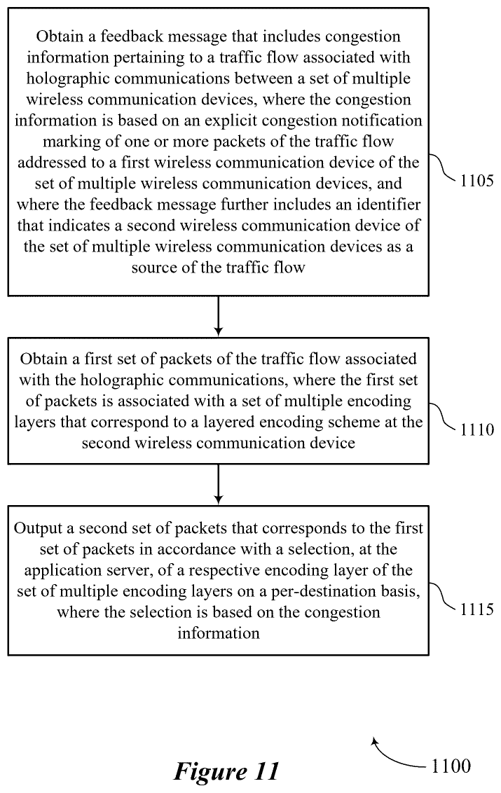

FIG. 11 shows an example flowchart of a method 1100 that supports coding rate control for holographic communications. Operations of the method 1100 may be performed by a network entity 105 or its components (such as using a processing system configured to cause the network entity to perform one or more operations) as described herein.

At 1105, the method may include obtaining a feedback message that includes congestion information pertaining to a traffic flow associated with holographic communications between a set of multiple wireless communication devices, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow. The feedback message may be an example of an ECN feedback message of FIGS. 3A, 3B, 4, 5, and 6, such as the ECN feedback obtained at 428 of FIG. 4. The multiple wireless communication devices may include wireless communication devices associated with one or more users, such as UEs 115 or devices 210. In some examples, aspects of the operations of 1105 may be performed by a feedback component 725. Additionally, or alternatively, the processing system 820 of the device 805 may be configured to cause the device 805 to perform aspects of the operations of 1105, as described with reference to FIG. 8.

At 1110, the method may include obtaining a first set of packets of the traffic flow associated with the holographic communications, where the first set of packets is associated with a set of multiple encoding layers that correspond to a layered encoding scheme at the second wireless communication device. For example, the first set of packets may be obtained at 418 of FIG. 4. In some examples, aspects of the operations of 1110 may be performed by a traffic forwarding component 730. Additionally, or alternatively, the processing system 820 of the device 805 may be configured to cause the device 805 to perform aspects of the operations of 1110, as described with reference to FIG. 8.

At 1115, the method may include outputting a second set of packets that corresponds to the first set of packets in accordance with a selection, at the application server, of a respective encoding layer of the set of multiple encoding layers on a per-destination basis, where the selection is based on the congestion information. Such a selection may be associated with the encoding layer selection at 416 and/or at 430 of FIG. 4. In some examples, aspects of the operations of 1115 may be performed by an encoding layer selection component 735. Additionally, or alternatively, the processing system 820 of the device 805 may be configured to cause the device 805 to perform aspects of the operations of 1115, as described with reference to FIG. 8.

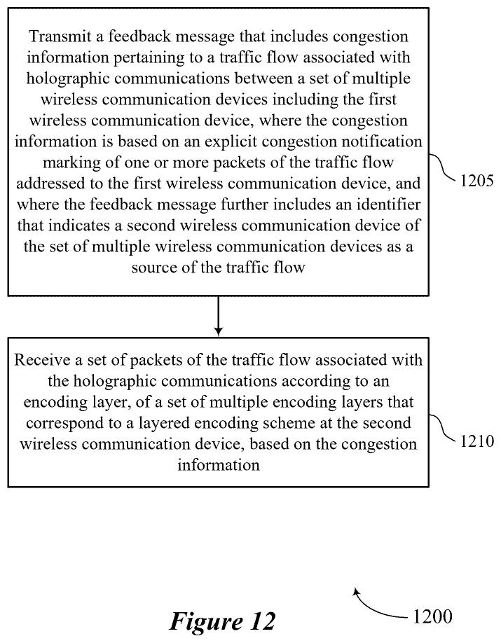

FIG. 12 shows an example flowchart of a method 1200 that supports coding rate control for holographic communications. Operations of the method 1200 may be performed by a UE or its components (such as using a processing system configured to cause the UE 115 to perform one or more of the operations) as described herein.

At 1205, the method may include transmitting a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow. The feedback message may be an example of an ECN feedback message of FIGS. 3A, 3B, 4, 5, and 6, such as the ECN feedback transmitted at 428 of FIG. 4. The multiple wireless communication devices may include wireless communication devices associated with one or more users, such as UEs 115 or devices 210. In some examples, aspects of the operations of 1205 may be performed by a feedback component 925. Additionally, or alternatively, the processing system 1020 of the device 1005 may be configured to cause the device 1005 to perform aspects of the operations of 1205, as described with reference to FIG. 10.

At 1210, the method may include receiving a set of packets of the traffic flow associated with the holographic communications according to an encoding layer, of a set of multiple encoding layers that correspond to a layered encoding scheme at the second wireless communication device, based on the congestion information. Such a set of packets may be a set of packets received at 438 of FIG. 4. In some examples, aspects of the operations of 1210 may be performed by a holographic communications component 930. Additionally, or alternatively, the processing system 1020 of the device 1005 may be configured to cause the device 1005 to perform aspects of the operations of 1210, as described with reference to FIG. 10.

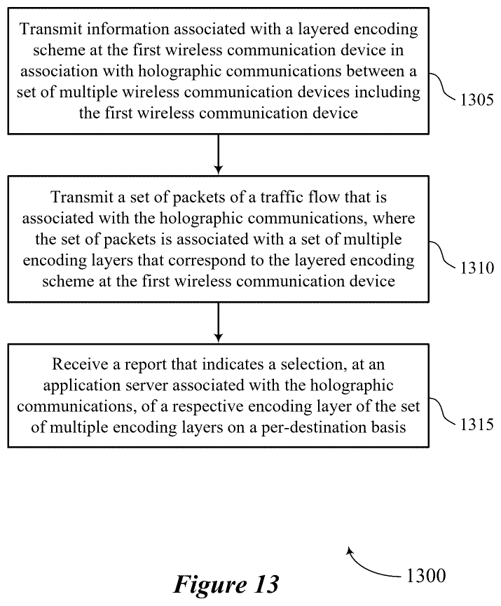

FIG. 13 shows an example flowchart of a method 1300 that supports coding rate control for holographic communications. Operations of the method 1300 may be performed by a UE or its components (such as using a processing system configured to cause the UE 115 to perform one or more of the operations) as described herein.

At 1305, the method may include transmitting information associated with a layered encoding scheme at the first wireless communication device in association with holographic communications between a set of multiple wireless communication devices including the first wireless communication device. Such information may include an indication of a set of available layers at 414 of FIG. 4. In some examples, aspects of the operations of 1305 may be performed by a layered encoding component 935. Additionally, or alternatively, the processing system 1020 of the device 1005 may be configured to cause the device 1005 to perform aspects of the operations of 1305, as described with reference to FIG. 10.

At 1310, the method may include transmitting a set of packets of a traffic flow that is associated with the holographic communications, where the set of packets is associated with a set of multiple encoding layers that correspond to the layered encoding scheme at the first wireless communication device. Such a set of packets may be a set of packets transmitted at 418 of FIG. 4. In some examples, aspects of the operations of 1310 may be performed by a holographic communications component 930. Additionally, or alternatively, the processing system 1020 of the device 1005 may be configured to cause the device 1005 to perform aspects of the operations of 1310, as described with reference to FIG. 10.

At 1315, the method may include receiving a report that indicates a selection, at an application server associated with the holographic communications, of a respective encoding layer of the set of multiple encoding layers on a per-destination basis. Such a report may be a report that an application server provides to a transmitting client in accordance with performing an encoding layer selection at 416 and/or at 430. In some examples, aspects of the operations of 1315 may be performed by a layered encoding component 935. Additionally, or alternatively, the processing system 1020 of the device 1005 may be configured to cause the device 1005 to perform aspects of the operations of 1315, as described with reference to FIG. 10.

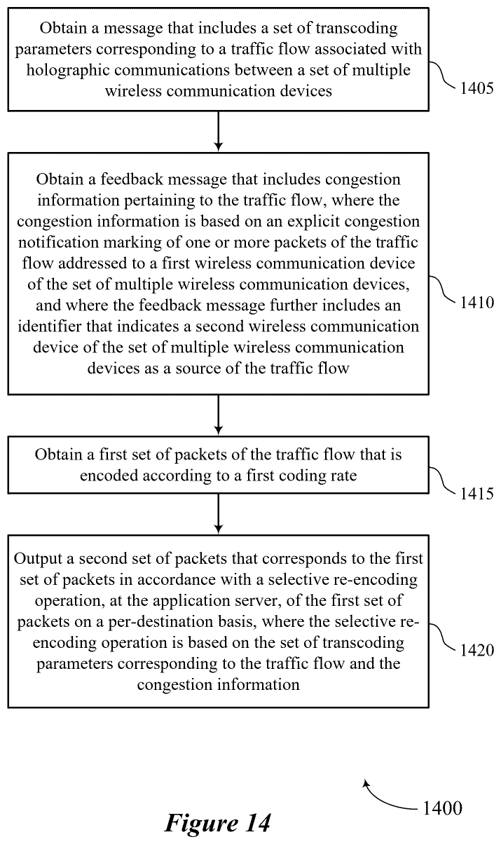

FIG. 14 shows an example flowchart of a method 1400 that supports coding rate control for holographic communications. Operations of the method 1400 may be performed by a network entity 105 or its components (such as using a processing system configured to cause the network entity to perform one or more operations) as described herein.

At 1405, the method may include obtaining a message that includes a set of transcoding parameters corresponding to a traffic flow associated with holographic communications between a set of multiple wireless communication devices. Such a set of transcoding parameters may be provided via the manifest file obtained at 512 of FIG. 5. In some examples, aspects of the operations of 1405 may be performed by a transcoding component 740. Additionally, or alternatively, the processing system 820 of the device 805 may be configured to cause the device 805 to perform aspects of the operations of 1405, as described with reference to FIG. 8.

At 1410, the method may include obtaining a feedback message that includes congestion information pertaining to the traffic flow, where the congestion information is based on an explicit congestion notification marking of one or more packets of the traffic flow addressed to a first wireless communication device of the set of multiple wireless communication devices, and where the feedback message further includes an identifier that indicates a second wireless communication device of the set of multiple wireless communication devices as a source of the traffic flow. The feedback message may be an example of an ECN feedback message of FIGS. 3A, 3B, 4, 5, and 6, such as the ECN feedback obtained at 526 of FIG. 5. In some examples, aspects of the operations of 1410 may be performed by a feedback component 725. Additionally, or alternatively, the processing system 820 of the device 805 may be configured to cause the device 805 to perform aspects of the operations of 1410, as described with reference to FIG. 8.

At 1415, the method may include obtaining a first set of packets of the traffic flow that is encoded according to a first coding rate. Such a first set of packets may include a set of packets obtained at 516 and/or 528 of FIG. 5. In some examples, aspects of the operations of 1415 may be performed by a traffic forwarding component 730. Additionally, or alternatively, the processing system 820 of the device 805 may be configured to cause the device 805 to perform aspects of the operations of 1415, as described with reference to FIG. 8.

At 1420, the method may include outputting a second set of packets that corresponds to the first set of packets in accordance with a selective re-encoding operation, at the application server, of the first set of packets on a per-destination basis, where the selective re-encoding operation is based on the set of transcoding parameters corresponding to the traffic flow and the congestion information. Such a selective re-encoding operation may be performed at 534 of FIG. 5. The second set of packets may include a set of packets output at 536 of FIG. 5. In some examples, aspects of the operations of 1420 may be performed by a transcoding component 740. Additionally, or alternatively, the processing system 820 of the device 805 may be configured to cause the device 805 to perform aspects of the operations of 1420, as described with reference to FIG. 8.

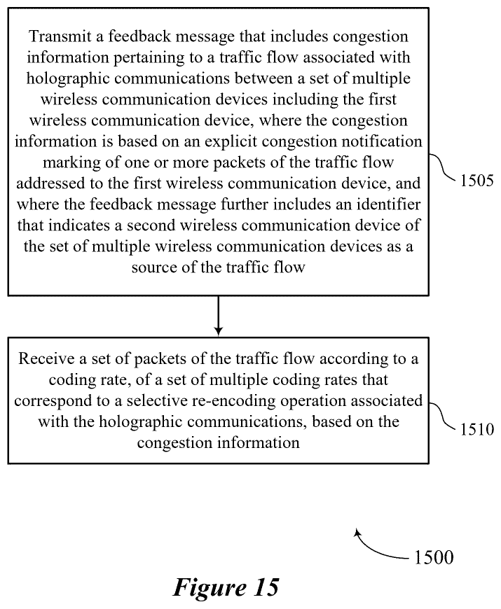

FIG. 15 shows an example flowchart of a method 1500 that supports coding rate control for holographic communications. Operations of the method 1500 may be performed by a UE or its components (such as using a processing system configured to cause the UE 115 to perform one or more of the operations) as described herein.

At 1505, the method may include transmitting a feedback message that includes congestion information pertaining to a traffic flow associated with holographic communications between a set of multiple wireless communication devices including the first wireless communication device, where the congestion information is based on an explicit congestion notification marking of one or more packets of the traffic flow addressed to the first wireless communication device, and where the feedback message further includes an identifier that indicates a second wireless communication device of the set of multiple wireless communication devices as a source of the traffic flow. The feedback message may be an example of an ECN feedback message of FIGS. 3A, 3B, 4, 5, and 6, such as the ECN feedback transmitted at 526 of FIG. 5. In some examples, aspects of the operations of 1505 may be performed by a feedback component 925. Additionally, or alternatively, the processing system 1020 of the device 1005 may be configured to cause the device 1005 to perform aspects of the operations of 1505, as described with reference to FIG. 10.

At 1510, the method may include receiving a set of packets of the traffic flow according to a coding rate, of a set of multiple coding rates that correspond to a selective re-encoding operation associated with the holographic communications, based on the congestion information. Such a set of packets may include a set of packets received at 536 of FIG. 5. In some examples, aspects of the operations of 1510 may be performed by a holographic communications component 930. Additionally, or alternatively, the processing system 1020 of the device 1005 may be configured to cause the device 1005 to perform aspects of the operations of 1510, as described with reference to FIG. 10.

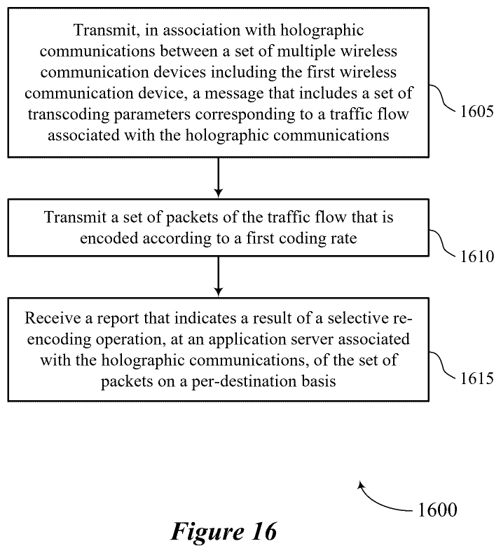

FIG. 16 shows an example flowchart of a method 1600 that supports coding rate control for holographic communications. Operations of the method 1600 may be performed by a UE or its components (such as using a processing system configured to cause the UE 115 to perform one or more of the operations) as described herein.

At 1605, the method may include transmitting, in association with holographic communications between a set of multiple wireless communication devices including the first wireless communication device, a message that includes a set of transcoding parameters corresponding to a traffic flow associated with the holographic communications. Such a set of transcoding parameters may be transmitted via the manifest file at 512 of FIG. 5. In some examples, aspects of the operations of 1605 may be performed by a transcoding component 940. Additionally, or alternatively, the processing system 1020 of the device 1005 may be configured to cause the device 1005 to perform aspects of the operations of 1605, as described with reference to FIG. 10.

At 1610, the method may include transmitting a set of packets of the traffic flow that is encoded according to a first coding rate. Such a set of packets may include a set of packets transmitted at 516 and/or at 528 of FIG. 5. In some examples, aspects of the operations of 1610 may be performed by a holographic communications component 930. Additionally, or alternatively, the processing system 1020 of the device 1005 may be configured to cause the device 1005 to perform aspects of the operations of 1610, as described with reference to FIG. 10.

At 1615, the method may include receiving a report that indicates a result of a selective re-encoding operation, at an application server associated with the holographic communications, of the set of packets on a per-destination basis. Such a report may be a report transmitted by an application server after the application server selectively re-encodes a set of packets at 534 of FIG. 5. In some examples, aspects of the operations of 1615 may be performed by a transcoding component 940. Additionally, or alternatively, the processing system 1020 of the device 1005 may be configured to cause the device 1005 to perform aspects of the operations of 1615, as described with reference to FIG. 10.

Implementation examples are described in the following numbered aspects:

Aspect 1: A method for wireless communication at an application server, comprising: obtaining a feedback message that comprises congestion information pertaining to a traffic flow associated with holographic communications between a plurality of wireless communication devices, wherein the congestion information is based at least in part on an explicit congestion notification marking of one or more packets of the traffic flow addressed to a first wireless communication device of the plurality of wireless communication devices, and wherein the feedback message further comprises an identifier that indicates a second wireless communication device of the plurality of wireless communication devices as a source of the traffic flow; obtaining a first set of packets of the traffic flow associated with the holographic communications, wherein the first set of packets is associated with a plurality of encoding layers that correspond to a layered encoding scheme at the second wireless communication device; and outputting a second set of packets that corresponds to the first set of packets in accordance with a selection, at the application server, of a respective encoding layer of the plurality of encoding layers on a per-destination basis, wherein the selection is based at least in part on the congestion information.

Aspect 2: The method of aspect 1, wherein outputting the second set of packets comprises: outputting a first coded version of the second set of packets according to a first encoding layer of the plurality of encoding layers based at least in part on the congestion information, wherein a first destination of the first coded version of the second set of packets is the first wireless communication device; and outputting a second coded version of the second set of packets according to a second encoding layer of the plurality of encoding layers different than the first encoding layer, wherein a second destination of the second coded version of the second set of packets is a third wireless communication device of the plurality of wireless communication devices.

Aspect 3: The method of aspect 2, wherein obtaining the first set of packets comprises: obtaining the first coded version of the first set of packets according to the first encoding layer; and obtaining the second coded version of the first set of packets according to the second encoding layer, wherein the selection comprises selecting the first coded version of the first set of packets to be output to the first wireless communication device and selecting the second coded version of the first set of packets to be output to the third wireless communication device.

Aspect 4: The method of any of aspects 2-3, wherein the first encoding layer is associated with a lower coding rate than the second encoding layer.

Aspect 5: The method of aspect 4, wherein packets of the traffic flow addressed to the third wireless communication device are absent of any explicit congestion notification marking, and the first encoding layer is associated with the lower coding rate than the second encoding layer in accordance with the packets of the traffic flow addressed to the third wireless communication device being absent of any explicit congestion notification marking.

Aspect 6: The method of any of aspects 1-5, further comprising: obtaining a third set of packets of the traffic flow; and outputting a fourth set of packets that corresponds to the third set of packets to each wireless communication device of the plurality of wireless communication devices other than the second wireless communication device, wherein the one or more packets with the explicit congestion notification marking are at least a subset of the fourth set of packets that are output to the first wireless communication device, and wherein obtaining the feedback message is in accordance with outputting the fourth set of packets.

Aspect 7: The method of any of aspects 1-6, further comprising: obtaining information associated with the layered encoding scheme at the second wireless communication device, wherein the selection is further based at least in part on the information associated with the layered encoding scheme.

Aspect 8: The method of aspect 7, wherein the information associated with the layered encoding scheme indicates whether the second wireless communication device utilizes the layered encoding scheme.

Aspect 9: The method of any of aspects 7-8, wherein the information associated with the layered encoding scheme indicates the plurality of encoding layers and one or more respective encoding parameters associated with each encoding layer of the plurality of encoding layers.

Aspect 10: The method of any of aspects 1-9, further comprising: outputting a report that indicates the selection, at the application server, of the respective encoding layer of the plurality of encoding layers on the per-destination basis.

Aspect 11: The method of aspect 10, further comprising: obtaining updated information associated with the layered encoding scheme at the second wireless communication device in accordance with outputting the report that indicates the selection, wherein the updated information indicates at least one of whether the second wireless communication device utilizes the layered encoding scheme or an updated plurality of encoding layers and one or more respective encoding parameters associated with each encoding layer of the updated plurality of encoding layers.

Aspect 12: The method of any of aspects 10-11, further comprising: obtaining configuration information that indicates a reporting configuration associated with the selection, wherein outputting the report that indicates the selection is in accordance with the reporting configuration.

Aspect 13: The method of aspect 12, wherein the reporting configuration is associated with at least one of a reporting condition, a reporting period, or a triggering event.

Aspect 14: The method of any of aspects 12-13, wherein outputting the report that indicates the selection or obtaining the configuration information that indicates the reporting configuration is via a first channel that is different than a second channel associated with the holographic communications.

Aspect 15: The method of any of aspects 1-14, further comprising: obtaining link condition information associated with a wireless communication link between the first wireless communication device and a network entity, wherein the selection is further based at least in part on the link condition information.

Aspect 16: The method of aspect 15, wherein obtaining the link condition information comprises: obtaining the link condition information via a cross-layer application programming interface associated with a modem of the first wireless communication device.

Aspect 17: The method of any of aspects 15-16, further comprising: outputting configuration information that indicates a reporting configuration associated with the link condition information, wherein obtaining the link condition information is in accordance with the reporting configuration.

Aspect 18: The method of aspect 17, wherein the reporting configuration is associated with at least one of a set of reporting objects, a list of available encoding layers, a reporting condition, a reporting period, or a triggering event.

Aspect 19: The method of any of aspects 17-18, wherein obtaining the link condition information or outputting the configuration information that indicates the reporting configuration is via a first channel that is different than a second channel associated with the holographic communications.

Aspect 20: The method of any of aspects 1-19, further comprising: outputting information that indicates the plurality of encoding layers associated with the layered encoding scheme at the second wireless communication device.

Aspect 21: The method of any of aspects 1-20, further comprising: detecting that a set of packets associated with the traffic flow from the second wireless communication device is associated with one or more explicit congestion notification markings; and outputting a second feedback message that comprises second congestion information pertaining to the traffic flow, wherein the second congestion information is based at least in part on the one or more explicit congestion notification markings of the set of packets from the second wireless communication device.

Aspect 22: The method of aspect 21, further comprising: removing the one or more explicit congestion notification markings from the set of packets from the second wireless communication device prior to outputting the set of packets to each wireless communication device of the plurality of wireless communication devices other than the second wireless communication device.

Aspect 23: The method of any of aspects 1-22, wherein the second set of packets is a forwarded version of the first set of packets from the second wireless communication device to each wireless communication device of the plurality of wireless communication devices other than the second wireless communication device.

Aspect 24: A method for wireless communication at a first wireless communication device, comprising: transmitting a feedback message that comprises congestion information pertaining to a traffic flow associated with holographic communications between a plurality of wireless communication devices including the first wireless communication device, wherein the congestion information is based at least in part on an explicit congestion notification marking of one or more packets of the traffic flow addressed to the first wireless communication device, and wherein the feedback message further comprises an identifier that indicates a second wireless communication device of the plurality of wireless communication devices as a source of the traffic flow; and receiving a set of packets of the traffic flow associated with the holographic communications according to an encoding layer, of a plurality of encoding layers that correspond to a layered encoding scheme at the second wireless communication device, based at least in part on the congestion information.

Aspect 25: The method of aspect 24, further comprising: receiving a second set of packets of the traffic flow associated with the holographic communications, wherein the one or more packets with the explicit congestion notification marking are at least a subset of the second set of packets, and wherein transmitting the feedback message is in accordance with receiving the second set of packets.

Aspect 26: The method of any of aspects 24-25, further comprising: transmitting link condition information associated with a wireless communication link between the first wireless communication device and a network entity, wherein receiving the set of packets of the traffic flow according to the encoding layer, of the plurality of encoding layers that correspond to the layered encoding scheme at the second wireless communication device, is further based at least in part on the link condition information.

Aspect 27: The method of aspect 26, wherein transmitting the link condition information comprises: transmitting the link condition information via a cross-layer application programming interface associated with a modem of the first wireless communication device.

Aspect 28: The method of any of aspects 26-27, further comprising: receiving information that indicates a reporting configuration associated with the link condition information, wherein transmitting the link condition information is in accordance with the reporting configuration.

Aspect 29: The method of aspect 28, wherein the reporting configuration is associated with at least one of a set of reporting objects, a list of available encoding layers, a reporting condition, a reporting period, or a triggering event.

Aspect 30: The method of any of aspects 28-29, wherein transmitting the link condition information or receiving the information that indicates the reporting configuration is via a first channel that is different than a second channel associated with the holographic communications.

Aspect 31: The method of any of aspects 24-30, further comprising: receiving information that indicates the plurality of encoding layers associated with the layered encoding scheme at the second wireless communication device.

Aspect 32: The method of aspect 31, further comprising: transmitting an uplink message that indicates the plurality of encoding layers associated with the layered encoding scheme at the second wireless communication device, wherein a radio access network associated with the first wireless communication device is based at least in part on the plurality of encoding layers associated with the layered encoding scheme at the second wireless communication device.

Aspect 33: A method for wireless communication at a first wireless communication device, comprising: transmitting information associated with a layered encoding scheme at the first wireless communication device in association with holographic communications between a plurality of wireless communication devices including the first wireless communication device; transmitting a set of packets of a traffic flow that is associated with the holographic communications, wherein the set of packets is associated with a plurality of encoding layers that correspond to the layered encoding scheme at the first wireless communication device; and receiving a report that indicates a selection, at an application server associated with the holographic communications, of a respective encoding layer of the plurality of encoding layers on a per-destination basis.

Aspect 34: The method of aspect 33, wherein the selection is based at least in part on congestion information associated with a second wireless communication device of the plurality of wireless communication devices, and the congestion information is based at least in part on an explicit congestion notification marking of one or more packets of the traffic flow addressed to the second wireless communication device.

Aspect 35: The method of any of aspects 33-34, wherein transmitting the set of packets comprises: transmitting a first coded version of the set of packets according to a first encoding layer of the plurality of encoding layers; and transmitting a second coded version of the set of packets according to a second encoding layer of the plurality of encoding layers.

Aspect 36: The method of aspect 35, wherein the first encoding layer is associated with a different coding rate than the second encoding layer.

Aspect 37: The method of any of aspects 33-36, wherein the information associated with the layered encoding scheme indicates whether the first wireless communication device utilizes the layered encoding scheme.

Aspect 38: The method of any of aspects 33-37, wherein the information associated with the layered encoding scheme indicates the plurality of encoding layers and one or more respective encoding parameters associated with each encoding layer of the plurality of encoding layers.

Aspect 39: The method of any of aspects 33-38, further comprising: transmitting updated information associated with the layered encoding scheme at the first wireless communication device in accordance with receiving the report that indicates the selection, wherein the updated information indicates at least one of whether the first wireless communication device utilizes the layered encoding scheme or an updated plurality of encoding layers and one or more respective encoding parameters associated with each encoding layer of the updated plurality of encoding layers.

Aspect 40: The method of any of aspects 33-39, further comprising: transmitting configuration information that indicates a reporting configuration associated with the selection, wherein receiving the report that indicates the selection is in accordance with the reporting configuration.

Aspect 41: The method of aspect 40, wherein the reporting configuration is associated with at least one of a reporting condition, a reporting period, or a triggering event.

Aspect 42: The method of any of aspects 40-41, wherein receiving the report that indicates the selection or transmitting the configuration information that indicates the reporting configuration is via a first channel that is different than a second channel associated with the holographic communications.

Aspect 43: The method of any of aspects 33-42, further comprising: transmitting an uplink message that indicates the plurality of encoding layers associated with the layered encoding scheme at the first wireless communication device, wherein a radio access network associated with the first wireless communication device is based at least in part on the plurality of encoding layers associated with the layered encoding scheme at the first wireless communication device.

Aspect 44: A method for wireless communication at an application server, comprising: obtaining a message that comprises a set of transcoding parameters corresponding to a traffic flow associated with holographic communications between a plurality of wireless communication devices; obtaining a feedback message that comprises congestion information pertaining to the traffic flow, wherein the congestion information is based at least in part on an explicit congestion notification marking of one or more packets of the traffic flow addressed to a first wireless communication device of the plurality of wireless communication devices, and wherein the feedback message further comprises an identifier that indicates a second wireless communication device of the plurality of wireless communication devices as a source of the traffic flow; obtaining a first set of packets of the traffic flow that is encoded according to a first coding rate; and outputting a second set of packets that corresponds to the first set of packets in accordance with a selective re-encoding operation, at the application server, of the first set of packets on a per-destination basis, wherein the selective re-encoding operation is based at least in part on the set of transcoding parameters corresponding to the traffic flow and the congestion information.

Aspect 45: The method of aspect 44, wherein outputting the second set of packets comprises: outputting a first coded version of the second set of packets that is encoded according to the first coding rate, wherein a first destination of the first coded version of the second set of packets is a third wireless communication device of the plurality of wireless communication devices; and outputting a second coded version of the second set of packets that is encoded according to a second coding rate different than the first coding rate based at least in part on the set of transcoding parameters and the congestion information, wherein a second destination of the second coded version of the second set of packets is the first wireless communication device.

Aspect 46: The method of aspect 45, wherein the second coding rate is lower than the first coding rate.

Aspect 47: The method of any of aspects 45-46, wherein packets of the traffic flow addressed to the third wireless communication device are absent of any explicit congestion notification marking, and the second coding rate is lower than the first coding rate in accordance with the packets of the traffic flow addressed to the third wireless communication device being absent of any explicit congestion notification marking.

Aspect 48: The method of any of aspects 44-47, further comprising: obtaining a third set of packets of the traffic flow; and outputting a fourth set of packets that corresponds to the third set of packets to each wireless communication device of the plurality of wireless communication devices other than the second wireless communication device, wherein the one or more packets with the explicit congestion notification marking are at least a subset of the fourth set of packets, and wherein obtaining the feedback message is in accordance with outputting the fourth set of packets.

Aspect 49: The method of any of aspects 44-48, wherein obtaining the message that comprises the set of transcoding parameters comprises: obtaining the message via a first channel that is different than a second channel associated with the holographic communications.

Aspect 50: The method of any of aspects 44-49, wherein obtaining the message that comprises the set of transcoding parameters comprises: obtaining the message at a beginning of a call associated with the holographic communications or at any time during the call associated with the holographic communications.

Aspect 51: The method of any of aspects 44-50, further comprising: outputting a report that indicates a result of the selective re-encoding operation, at the application server, of the first set of packets on the per-destination basis.

Aspect 52: The method of aspect 51, further comprising: obtaining configuration information that indicates a reporting configuration associated with the result of the selective re-encoding operation, wherein outputting the report that indicates the result of the selective re-encoding operation is in accordance with the reporting configuration.

Aspect 53: The method of aspect 52, wherein the reporting configuration is associated with at least one of a reporting condition, a reporting period, or a triggering event.

Aspect 54: The method of any of aspects 52-53, wherein outputting the report that indicates the result of the selective re-encoding operation or obtaining the configuration information that indicates the reporting configuration is via a first channel that is different than a second channel associated with the holographic communications.

Aspect 55: The method of any of aspects 44-54, further comprising: obtaining link condition information associated with a wireless communication link between the first wireless communication device and a network entity, wherein the selective re-encoding operation is further based at least in part on the link condition information.

Aspect 56: The method of aspect 55, wherein obtaining the link condition information comprises: obtaining the link condition information via a cross-layer application programming interface associated with a modem of the first wireless communication device.

Aspect 57: The method of any of aspects 55-56, further comprising: outputting configuration information that indicates a reporting configuration associated with the link condition information, wherein obtaining the link condition information is in accordance with the reporting configuration.

Aspect 58: The method of aspect 57, wherein the reporting configuration is associated with at least one of a set of reporting objects, a list of available bit rates, a reporting condition, a reporting period, or a triggering event.

Aspect 59: The method of any of aspects 57-58, wherein obtaining the link condition information or outputting the configuration information that indicates the reporting configuration is via a first channel that is different than a second channel associated with the holographic communications.

Aspect 60: The method of any of aspects 44-59, further comprising: outputting information that indicates the set of transcoding parameters corresponding to the traffic flow.

Aspect 61: The method of any of aspects 44-60, further comprising: detecting that a set of packets associated with the traffic flow from the second wireless communication device are associated with one or more explicit congestion notification markings; and outputting a second feedback message that comprises second congestion information pertaining to the traffic flow, wherein the second congestion information is based at least in part on the one or more explicit congestion notification markings of the set of packets from the second wireless communication device.

Aspect 62: The method of aspect 61, further comprising: removing the one or more explicit congestion notification markings from the set of packets from the second wireless communication device prior to outputting the set of packets to each wireless communication device of the plurality of wireless communication devices other than the second wireless communication device.

Aspect 63: The method of any of aspects 44-62, wherein the second set of packets is a forwarded version of the first set of packets from the second wireless communication device to each wireless communication device of the plurality of wireless communication devices other than the second wireless communication device.

Aspect 64: A method for wireless communication at a first wireless communication device, comprising: transmitting a feedback message that comprises congestion information pertaining to a traffic flow associated with holographic communications between a plurality of wireless communication devices including the first wireless communication device, wherein the congestion information is based at least in part on an explicit congestion notification marking of one or more packets of the traffic flow addressed to the first wireless communication device, and wherein the feedback message further comprises an identifier that indicates a second wireless communication device of the plurality of wireless communication devices as a source of the traffic flow; and receiving a set of packets of the traffic flow according to a coding rate, of a plurality of coding rates that correspond to a selective re-encoding operation associated with the holographic communications, based at least in part on the congestion information.

Aspect 65: The method of aspect 64, further comprising: receiving a second set of packets of the traffic flow, wherein the one or more packets with the explicit congestion notification marking are at least a subset of the second set of packets, and wherein transmitting the feedback message is in accordance with receiving the second set of packets.

Aspect 66: The method of any of aspects 64-65, further comprising: transmitting link condition information associated with a wireless communication link between the first wireless communication device and a network entity, wherein the selective re-encoding operation is further based at least in part on the link condition information.

Aspect 67: The method of aspect 66, wherein transmitting the link condition information comprises: transmitting the link condition information via a cross-layer application programming interface associated with a modem of the first wireless communication device.

Aspect 68: The method of any of aspects 66-67, further comprising: receiving configuration information that indicates a reporting configuration associated with the link condition information, wherein transmitting the link condition information is in accordance with the reporting configuration.

Aspect 69: The method of aspect 68, wherein the reporting configuration is associated with at least one of a set of reporting objects, a list of available bit rates, a reporting condition, a reporting period, or a triggering event.

Aspect 70: The method of any of aspects 68-69, wherein transmitting the link condition information or receiving the configuration information that indicates the reporting configuration is via a first channel that is different than a second channel associated with the holographic communications.

Aspect 71: The method of any of aspects 64-70, further comprising: receiving information that indicates a set of transcoding parameters corresponding to the traffic flow, wherein the selective re-encoding operation is in accordance with the set of transcoding parameters.

Aspect 72: The method of aspect 71, further comprising: transmitting an uplink message that indicates the set of transcoding parameters, wherein a radio access network associated with the first wireless communication device is based at least in part on the set of transcoding parameters.

Aspect 73: A method for wireless communication at a first wireless communication device, comprising: transmitting, in association with holographic communications between a plurality of wireless communication devices including the first wireless communication device, a message that comprises a set of transcoding parameters corresponding to a traffic flow associated with the holographic communications; transmitting a set of packets of the traffic flow that is encoded according to a first coding rate; and receiving a report that indicates a result of a selective re-encoding operation, at an application server associated with the holographic communications, of the set of packets on a per-destination basis.

Aspect 74: The method of aspect 73, further comprising: updating a coding rate associated with the traffic flow from the first coding rate to a second coding rate based at least in part on the result of the selective re-encoding operation.

Aspect 75: The method of any of aspects 73-74, wherein transmitting the message that comprises the set of transcoding parameters comprises: transmitting the message via a first channel that is different than a second channel associated with the holographic communications.

Aspect 76: The method of any of aspects 73-75, wherein transmitting the message that comprises the set of transcoding parameters comprises: transmitting the message at a beginning of a call associated with the holographic communications or at any time during the call associated with the holographic communications.

Aspect 77: The method of any of aspects 73-76, further comprising: transmitting configuration information that indicates a reporting configuration associated with the result of the selective re-encoding operation, wherein receiving the report that indicates the result of the selective re-encoding operation is in accordance with the reporting configuration.

Aspect 78: The method of aspect 77, wherein the reporting configuration is associated with at least one of a reporting condition, a reporting period, or a triggering event.

Aspect 79: The method of any of aspects 77-78, wherein receiving the report that indicates the result of the selective re-encoding operation or transmitting the configuration information that indicates the reporting configuration is via a first channel that is different than a second channel associated with the holographic communications.

Aspect 80: The method of any of aspects 73-79, further comprising: transmitting an uplink message that indicates a coding rate associated with the traffic flow, wherein a radio access network associated with the first wireless communication device is based at least in part on the coding rate.

Aspect 81: An application server for wireless communication, comprising a processing system that includes processor circuitry and memory circuitry that stores code, the processing system configured to cause the application server to perform a method of any of aspects 1-23.

Aspect 82: An application server for wireless communication, comprising at least one means for performing a method of any of aspects 1-23.

Aspect 83: A non-transitory computer-readable medium storing code for wireless communication, the code comprising instructions executable by one or more processors to perform a method of any of aspects 1-23.

Aspect 84: A first wireless communication device for wireless communication, comprising a processing system that includes processor circuitry and memory circuitry that stores code, the processing system configured to cause the first wireless communication device to perform a method of any of aspects 24-32.

Aspect 85: A first wireless communication device for wireless communication, comprising at least one means for performing a method of any of aspects 24-32.

Aspect 86: A non-transitory computer-readable medium storing code for wireless communication, the code comprising instructions executable by one or more processors to perform a method of any of aspects 24-32.

Aspect 87: A first wireless communication device for wireless communication, comprising a processing system that includes processor circuitry and memory circuitry that stores code, the processing system configured to cause the first wireless communication device to perform a method of any of aspects 33-43.

Aspect 88: A first wireless communication device for wireless communication, comprising at least one means for performing a method of any of aspects 33-43.

Aspect 89: A non-transitory computer-readable medium storing code for wireless communication, the code comprising instructions executable by one or more processors to perform a method of any of aspects 33-43.

Aspect 90: An application server for wireless communication, comprising a processing system that includes processor circuitry and memory circuitry that stores code, the processing system configured to cause the application server to perform a method of any of aspects 44-63.

Aspect 91: An application server for wireless communication, comprising at least one means for performing a method of any of aspects 44-63.

Aspect 92: A non-transitory computer-readable medium storing code for wireless communication, the code comprising instructions executable by one or more processors to perform a method of any of aspects 44-63.

Aspect 93: A first wireless communication device for wireless communication, comprising a processing system that includes processor circuitry and memory circuitry that stores code, the processing system configured to cause the first wireless communication device to perform a method of any of aspects 64-72.

Aspect 94: A first wireless communication device for wireless communication, comprising at least one means for performing a method of any of aspects 64-72.

Aspect 95: A non-transitory computer-readable medium storing code for wireless communication, the code comprising instructions executable by one or more processors to perform a method of any of aspects 64-72.

Aspect 96: A first wireless communication device for wireless communication, comprising a processing system that includes processor circuitry and memory circuitry that stores code, the processing system configured to cause the first wireless communication device to perform a method of any of aspects 73-80.

Aspect 97: A first wireless communication device for wireless communication, comprising at least one means for performing a method of any of aspects 73-80.

Aspect 98: A non-transitory computer-readable medium storing code for wireless communication, the code comprising instructions executable by one or more processors to perform a method of any of aspects 73-80.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, “outputting” may generally refer to outputting for transmission via one or more antennas, transmitting, sending, or otherwise providing (information, signaling, messaging) to another device, entity, functionality, or node. Outputting may include via wireless and/or wired signaling. Further, as used herein, “obtaining” may generally refer to obtaining from one or more antennas, receiving, selecting, or otherwise acquiring (information, signaling, messaging) from another device, entity, functionality, or node. Obtaining may include via wireless and/or wired signaling.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An application server, comprising:
a processing system that includes processor circuitry and memory circuitry that stores code, the processing system configured to cause the application server to:
obtain a feedback message that comprises congestion information pertaining to a traffic flow associated with holographic communications between a plurality of wireless communication devices, wherein the congestion information is based at least in part on an explicit congestion notification marking of one or more packets of the traffic flow addressed to a first wireless communication device of the plurality of wireless communication devices, and wherein the feedback message further comprises an identifier that indicates a second wireless communication device of the plurality of wireless communication devices as a source of the traffic flow;
obtain a first set of packets of the traffic flow associated with the holographic communications, wherein the first set of packets is associated with a plurality of encoding layers that correspond to a layered encoding scheme at the second wireless communication device; and
output a second set of packets that corresponds to the first set of packets in accordance with a selection, at the application server, of a respective encoding layer of the plurality of encoding layers on a per-destination basis, wherein the selection is based at least in part on the congestion information.

2. The application server of claim 1, wherein, to output the second set of packets, the processing system is configured to cause the application server to:
output a first coded version of the second set of packets according to a first encoding layer of the plurality of encoding layers based at least in part on the congestion information, wherein a first destination of the first coded version of the second set of packets is the first wireless communication device; and
output a second coded version of the second set of packets according to a second encoding layer of the plurality of encoding layers different than the first encoding layer, wherein a second destination of the second coded version of the second set of packets is a third wireless communication device of the plurality of wireless communication devices.

3. The application server of claim 2, wherein the first encoding layer is associated with a lower coding rate than the second encoding layer.

4. The application server of claim 3, wherein:
packets of the traffic flow addressed to the third wireless communication device are absent of any explicit congestion notification marking, and
the first encoding layer is associated with the lower coding rate than the second encoding layer in accordance with the packets of the traffic flow addressed to the third wireless communication device being absent of any explicit congestion notification marking.

5. The application server of claim 1, wherein the processing system is further configured to cause the application server to:
obtain information associated with the layered encoding scheme at the second wireless communication device, wherein the selection is further based at least in part on the information associated with the layered encoding scheme.

6. The application server of claim 5, wherein the information associated with the layered encoding scheme indicates:
whether the second wireless communication device utilizes the layered encoding scheme; and
the plurality of encoding layers and one or more respective encoding parameters associated with each encoding layer of the plurality of encoding layers.

7. The application server of claim 1, wherein the processing system is further configured to cause the application server to:
output a report that indicates the selection, at the application server, of the respective encoding layer of the plurality of encoding layers on the per-destination basis.

8. The application server of claim 7, wherein the processing system is further configured to cause the application server to:
obtain updated information associated with the layered encoding scheme at the second wireless communication device in accordance with outputting the report that indicates the selection, wherein the updated information indicates at least one of whether the second wireless communication device utilizes the layered encoding scheme or an updated plurality of encoding layers and one or more respective encoding parameters associated with each encoding layer of the updated plurality of encoding layers.

9. The application server of claim 7, wherein the processing system is further configured to cause the application server to:
obtain configuration information that indicates a reporting configuration associated with the selection, wherein outputting the report that indicates the selection is in accordance with the reporting configuration.

10. The application server of claim 1, wherein the processing system is further configured to cause the application server to:
obtain link condition information associated with a wireless communication link between the first wireless communication device and a network entity, wherein the selection is further based at least in part on the link condition information.

11. An application server, comprising:
a processing system that includes processor circuitry and memory circuitry that stores code, the processing system configured to cause the application server to:
obtain a message that comprises a set of transcoding parameters corresponding to a traffic flow associated with holographic communications between a plurality of wireless communication devices;
obtain a feedback message that comprises congestion information pertaining to the traffic flow, wherein the congestion information is based at least in part on an explicit congestion notification marking of one or more packets of the traffic flow addressed to a first wireless communication device of the plurality of wireless communication devices, and wherein the feedback message further comprises an identifier that indicates a second wireless communication device of the plurality of wireless communication devices as a source of the traffic flow;
obtain a first set of packets of the traffic flow that is encoded according to a first coding rate; and
output a second set of packets that corresponds to the first set of packets in accordance with a selective re-encoding operation, at the application server, of the first set of packets on a per-destination basis, wherein the selective re-encoding operation is based at least in part on the set of transcoding parameters corresponding to the traffic flow and the congestion information.

12. The application server of claim 11, wherein, to output the second set of packets, the processing system is configured to cause the application server to:
output a first coded version of the second set of packets that is encoded according to the first coding rate, wherein a first destination of the first coded version of the second set of packets is a third wireless communication device of the plurality of wireless communication devices; and
output a second coded version of the second set of packets that is encoded according to a second coding rate different than the first coding rate based at least in part on the set of transcoding parameters and the congestion information, wherein a second destination of the second coded version of the second set of packets is the first wireless communication device.

13. The application server of claim 12, wherein the second coding rate is lower than the first coding rate.

14. The application server of claim 12, wherein:
packets of the traffic flow addressed to the third wireless communication device are absent of any explicit congestion notification marking, and
the second coding rate is lower than the first coding rate in accordance with the packets of the traffic flow addressed to the third wireless communication device being absent of any explicit congestion notification marking.

15. The application server of claim 11, wherein, to obtain the message that comprises the set of transcoding parameters, the processing system is configured to cause the application server to:
obtain the message via a first channel that is different than a second channel associated with the holographic communications.

16. The application server of claim 11, wherein the processing system is further configured to cause the application server to:
output a report that indicates a result of the selective re-encoding operation, at the application server, of the first set of packets on the per-destination basis.

17. The application server of claim 16, wherein the processing system is further configured to cause the application server to:
obtain configuration information that indicates a reporting configuration associated with the result of the selective re-encoding operation, wherein outputting the report that indicates the result of the selective re-encoding operation is in accordance with the reporting configuration.

18. The application server of claim 11, wherein the processing system is further configured to cause the application server to:
obtain link condition information associated with a wireless communication link between the first wireless communication device and a network entity, wherein the selective re-encoding operation is further based at least in part on the link condition information.

19. A method for wireless communication at an application server, comprising:
obtaining a feedback message that comprises congestion information pertaining to a traffic flow associated with holographic communications between a plurality of wireless communication devices, wherein the congestion information is based at least in part on an explicit congestion notification marking of one or more packets of the traffic flow addressed to a first wireless communication device of the plurality of wireless communication devices, and wherein the feedback message further comprises an identifier that indicates a second wireless communication device of the plurality of wireless communication devices as a source of the traffic flow;
obtaining a first set of packets of the traffic flow associated with the holographic communications, wherein the first set of packets is associated with a plurality of encoding layers that correspond to a layered encoding scheme at the second wireless communication device; and
outputting a second set of packets that corresponds to the first set of packets in accordance with a selection, at the application server, of a respective encoding layer of the plurality of encoding layers on a per-destination basis, wherein the selection is based at least in part on the congestion information.

20. The method of claim 19, further comprising:
obtaining information associated with the layered encoding scheme at the second wireless communication device, wherein the selection is further based at least in part on the information associated with the layered encoding scheme, wherein:
the information associated with the layered encoding scheme indicates whether the second wireless communication device utilizes the layered encoding scheme, and
the information associated with the layered encoding scheme indicates the plurality of encoding layers and one or more respective encoding parameters associated with each encoding layer of the plurality of encoding layers.
